(19) United States
(12) Patent Application Publication
(10) Pub. No.: US 2003/0028782 A1
(43) Pub. Date: Feb. 6, 2003

(54) System and method for facilitating initiation and disposition of proceedings online within an access controlled environment

(76) Inventor: Joseph A. Grundfest, Palo Alto, CA (US)

Correspondence Address: Erik B. Cherdak, Esq., C/o Steptoe & Johnson, LLP, 1330 Connecticut Ave., N.W., Washington, DC, 20036, US

(21) Appl. No.: 10/136,689

(22) Filed: May 1, 2002

Related U.S. Application Data
(63) Continuation-in-part of application No. 09/718,097, filed on Nov. 22, 2000.

(51) Int. Cl. H04K 1/00

(52) U.S. Cl. 713/182

(57) ABSTRACT

System and method for facilitating initiation and disposition of an online motion (e.g., a motion filed and processed within the context of a legal proceeding, etc.) within an access controlled environment within the context of a court proceeding. The system and method include and involve an access control facility accessible via a global data processing network and configured to maintain user information, and to permit or deny a user to enter an access controlled environment within a data processing environment and to perform user operations within the access controlled environment related to the online motion. A transaction management facility is operable within the access controlled environment and is coupled to the access control facility, and is configured to store and maintain transaction data based on online motion, the user operations, and a security scheme. An authentication facility is operable within the access controlled environment and is configured to authenticate the transaction data based on an authentication scheme corresponding to the online motion. The transaction management facility, the access control facility, and the authentication facility operate together to facilitate disposition of the online motion.

### REFERENCE TO AND INCORPORATION OF RELATED PATENT APPLICATIONS

The instant patent document is a continuation-in-part patent application of U.S. patent application Ser. No. 09/718,097 filed on Nov. 22, 2000, which application is entitled “SYSTEM AND METHOD FOR FACILITATING TRANSACTION PROCESSING AND DISPOSITION WITHIN AN ACCESS CONTROLLED ENVIRONMENT VIA A GLOBAL NETWORK SUCH AS THE INTERNET,” is pending before the U.S. Patent and Trademark Office, and is hereby incorporated by reference.

### BACKGROUND OF THE INVENTION

1. Field of the Invention

The present invention relates to systems and methods used to manage and process documents and other data that require various levels of security and authentication as they are exchanged among multiple parties in the context of legal proceedings, commercial transaction, business negotiations and other similar interactions.

2. Description of the Related Art

The Internet and the World Wide Web (WWW) (hereinafter collectively referred to as the “Internet”) have changed the techniques by which people and organizations (public and private) communicate and transact in goods and services. The Internet enables people and organizations once separated by distance and time to now interact with each other without regard to distance and without imposing prior inefficiencies such as those realized by mail and post that inhibit transaction and communication. For example, buyers and sellers of goods from around the globe can now access online trading and auctioning systems to engage in transactions that heretofore have not been practical. To reach this point in its evolvement, the Internet had to undergo a series of significant evolutionary developments.

For example, at its popular inception in the mid-1990s, the Internet merely provided a network of information presentation and publication sites (web sites) at which site operators presented early network users with the ability to obtain mainly textual type information about an organization or about a product or service. Early web sites were often modeled after paper-based company and product brochures that contained pages of textual type material—hence the name “web page.” In other words, the early popular Internet was a content publishing vehicle that promoted the more efficient dissemination, publication and distribution of textual and visual information. Although widely accepted as an improved method providing information, at this stage of development, the Internet did nothing more than facilitate the distribution of information. Users of the Internet were still left to rely on old world techniques for transacting their business and conducting their affairs.

A subsequent state of the Internet came as a result of the phenomenon known as “e-commerce” and the easier ability to access the Internet. E-commerce is a term used to define the use of the Internet to facilitate the purchase and sale of goods and services to consumers online, via relatively secure transactions (e.g., encrypted transactions) and without requiring that the consumers visit a showroom or other sales facility. E-commerce, as a business paradigm, has lead to significant development of new industries. It has also led to the development of new distribution methods, substituted for pre-existing sales processes, and, in many respects, has enhanced competition in a free market economy such as in the United States. For example, retailing entities such as AMAZON.COM (www.amazon.com) completely and totally rely upon online transactions to sell books, music, and other goods and services. Consumers who visit AMAZON.COM can fill “electronic” shopping carts with goods (e.g., book titles) selected online, and then proceed to an “electronic” checkout where a credit card will be taken in the context of a secure online transaction. Ultimately, the goods purchased online will be shipped to the consumer from a warehouse or other clearinghouse. (AMAZON.COM is a trademark and/or a registered trademark of AMAZON.COM, INC.)

In terms of substituted sales processes, the Internet has provided opportunities for providers to change the roles played by parties in everyday transactions. For example, PRICELINE.COM (www.priceline.com) seems to reverse the roles played by buyer and seller in the context of a typical retail purchase transaction for airline tickets, hotel rooms, etc. Prior to the advent of PRICELINE.COM, an airline would act as an OFFEROR or the entity that offers a good or service for sale at a particular price, and the OFFEREE was the consumer that either accepted or declined the OFFEROR's offer. PRICELINE.COM changed that scenario by providing an e-commerce model known as “name your own price” wherein the consumer acts as the OFFEROR who presents a price which the consumer is willing to pay for a particular good or service. A seller such as an airline acting as the OFFEREE may either accept the consumer's offer or reject it. Once accepted, a previously stored credit card number corresponding to the consumer-OFFEREE automatically will be charged and tickets or some other notice will be issued by PRICELINE.COM and/or the seller. (PRICELINE.COM and “NAME YOUR OWN PRICE” are trademarks and/or registered trademarks of PRICELINE.COM, INC.)

In terms of communication, the Internet has lent its hand developing new and improved methods of communication, especially in recent years. For example, e-mail existed prior the popular inception of the Internet. Prior e-mail system utilized technologies such as EDI and other private networking technologies. These prior e-mail systems allowed limited communication only to a select group of subscribers, such as employees within a company. Now, the Internet allows e-mail subscribers to communicate with individuals outside of their private networks and virtually with anyone who has access to the Internet. The availability of e-mail over the Internet has made e-mail an incredibly popular means of communication. In fact, one could say that e-mail over the Internet has transcended communication. By providing a simple, inexpensive means of communicating to nearly anybody on the planet, e-mail has changed the way people communicate and increased the frequency of communications. However, e-mail systems are not without their shortcomings. For example, e-mail system are not regarded as entirely secure and do not provide sophisticated authentication of users and messages. Thus, e-mail may not be an appropriate vehicle for facilitation of many types of transactions.

A second communication technique that has substantially increased in popularity because of the Internet is instant messaging. Instant messaging services have existed for at least 16 years as a means for private, peer to peer communications over a network in near real-time. These services typically require a two active clients on the same network and allow users to send and receive messages directly from one another. Similar to the Internet's influence on e-mail, the Internet's wide availability has made instant messaging services on the Internet an extremely popular means for communicating. Also, like e-mail systems, instant messaging services do not provide sophisticated levels of security and authentication. Furthermore, instant messaging services require active clients in order to communicate, which means that if the proposed recipient of a message is not logged onto an instant messaging service, the message cannot be delivered. Thus, instant messaging services can be characterized as merely an alternative to the telephone.

Shared workspaces and file sharing techniques have similarly evolved with the help of the Internet. For example, NAPSTER.COM provides a means for Internet users to share MP3 files over the Internet.

Access means and methods have also played a major role in shaping the modern Internet. For example, users can now access the Internet via a wide variety of technologies including conventional dial-up connections, high-speed broad-band connections (e.g., ISDN, DSL, etc.), and wireless connections. A service that was once limited to dedicated access within large organizations and slow-speed dial-up type connections, can now be accessed via a variety of media that permit rich content delivery and manifestation and, ultimately, easier use of online information.

Another aspect of increased access, is that of the nature and type of access available to network users. For example, web sites now permit users to directly access account and service information in the context of bank accounts, credit card accounts and other account and personally stored information in terms of their user preferences for reviewing content and engaging in e-commerce transactions. For example, banks and other financial institutions (e.g., brokerage houses such as ETRADE.COM (www.etrade.com)) now permit users directly to access personal account information via secure sessions such as via access restricted and encrypted web sessions. Users can directly interact with their banks, for example, to transact account and money transfers between accounts and to transact stock and securities purchases related to publicly traded securities.

Despite the advances in e-commerce and access (both in terms of physical access and direct, secure access as discussed above) that have made the Internet the backbone of the “new” economy, the Internet remains deficient and problem ridden in many areas. That is, although the Internet now permits users such as account holders to directly and securely interact with their banking institutions, these users are unable to engage in broader exchanges of information in the context of transactions beyond typical purchase and sale and information look-up related transactions. In fact, careful review of the capabilities of the Internet indicate that the current state of the art is subject to a broad range of limitations that constitute fundamental barriers to the ability to apply the Internet to a broad range of transaction and communications that do not currently employ the Internet.

Consider for example, the case of adverse parties engaged in litigation or arbitration. The maintenance and resolution of this dispute can involve a broad array of participants. Each party to the dispute may be represented by one or more law firms, each relying on the services of several individual attorneys in the course of the representation. Each party may have its costs reimbursed in whole or in part by an insurer. Each party may have its own battery of experts, witnesses, and other participants in the proceeding. The proceeding will further be subject to the jurisdiction of a third party, such as a court or arbitrator that, depending on the circumstances with act as fact finder and/or apply the law to the facts to resolve the dispute.

Communications among these participants in effect create a network with several critical components. In some situations, communications must be structured so that they simultaneously must be viewed by some participants but must not be viewed by others. For example, a memorandum from counsel to client analyzing and describing a proposed obligation to forward settlement proposals but must not be viewed by opposing parties or counsel lest the attorney-client privilege be breached or valuable information flows to the opposition. In other situations, the court may wish that some communications be posted in a highly public manner. For example, in a class action proceeding or in a proceeding with a strong public interest, the court may order that certain documents be made public and that press releases and other techniques be employed to attract public notice to communication.

Throughout this process there will be concerns regarding the authenticity and security of communications. Counsel will for example, be interested in assuring that a communication that purports to come from a judge does in fact come from the judge. Counsel will also be interested in assuring that documents cannot be reviewed without permission and may further have an interest in creating “audit trails” that can track the identity of persons who have accessed specific documents.

The absence of a network that contains the requisite authentication and security features effectively precludes the use of the Internet as an efficient means for the online prosecution and resolution of a litigation or arbitration as an integrated whole, or even it material part.

Limitations on the current ability of the Internet to facilitate disposition of transactions is seen in the area of insurance claims and the like. For example, a party submitting a claim on an insurance policy as a consequence of an automobile accident may have to interact with an insurance adjuster about details of an accident, provide medical and related records, and provide first hand accounts of the events of the accident prior to realizing payment by the insurance company. In cases where the insurance company offers a payout settlement that for some reason does not meet the expectations of the insured, the insured may have no alternative but to sue or seek other redress against the insurer from a Court or other similar decision making body. The insured and insurer would then face the problems mentioned above with regard to litigation proceedings generally.

Another example of limitations of the current state of the art relate to the Internet's ability to facilitate transaction processing and disposition when transactions that currently occur in the non-online world require significant numbers of parties and/or involve highly individualized or transaction specific processes. For example, a transaction involving execution of a contract between parties may involve a customized set of obligations pertaining to the parties to the contract. The obligations may require production of documentation, contract management as in the case of non-disclosure agreements involving confidential disclosures between parties, consideration setting, and, possibly, settlement of contract disputes between the parties when contract obligations cannot be met or otherwise become frustrated. Furthermore, such transactions may require the authentications or verifications of documents, testimony, filings, etc., and varying secure levels of access to the same which have not heretofore been realized.

The current state of the art is subject to several limitations that inhibit the more robust usage of the Internet described above.

First, there are substantial barriers to the authentication of networks of individuals on the Internet. Although technology is readily available to tract users through their “cookies” or through other means, these technologies are generally one-to-one. There exists no efficient method or system whereby a network of individuals can have pre-specified levels of assurance that the other members of the network with whom they are communicating, are, indeed, who they claim to be. Thus, attorneys at Law Firm A are not able to efficiently authenticate the identity of attorneys at Law Firm B, and vice versa.

Second, because authentication can occur through a range of different techniques, such as simple password authentication, passwords combined with time-varying codes, biometric authentication, or any combination of the preceding forms of authentication, participants in a network of authenticated users may wish to specify the levels of authentication they request or demand in connection with a specific set of interactions. Again, the current state of the art does not facilitate such structured forms of authentication.

Third, participants in a network of authenticated users will reasonably desire a range of security levels in connection with their interactions. In some situation, participants may wish to assure that their interactions remain entirely private. In other situation, participants may desire that their communications be broadly open to public inspection. In yet other situations, participants may desire to transmit anonymously within the authenticated network, giving rise to a situation in which senders and/or receivers cannot be identified or tracked by third parties, but have assurances that each other is a member of the authenticated network. In still other situations, anonymous communications will be rejected and only identified, authenticated communications will be acceptable. The current state of the art does not provide for robust authenticated communication networks that provide multiple levels of or approaches to online data security, identity, and anonymity.

Fourth, the current state of the art does not provide for billing mechanisms that charge for traffic, data storage and other forms of online performance as a function of authentication levels and levels of security, or of the interaction between these tow factors.

In sum, the aforementioned deficiencies of the current Internet provide facilitation of certain versions of transaction (e.g., an inter-parties transaction, etc.) processing and disposition impossible or highly inefficient. Although very capable of facilitating and changing conventional purchase and sale transactions, of facilitating direct access between a user and his own personal data stored by a web-enabled server system as in the case of online banking, the current Internet cannot facilitate transaction processing and disposition that involves multiple parties and which requires customizable levels of security for party access to transactions processes and for document and data validity and authenticity. And, in addition to the deficiencies of the current Internet to facilitate transaction processing and disposition, others have not been able to modify or otherwise incorporate prior, legacy systems such as those used in fields of Electronic Data Interchange, Data Post and Notify Systems, and Electronic Messaging to name a few, into the current Internet. In essence, providers attempting to incorporate such legacy systems will face producing systems which become highly fragmented due the disparity of the systems used by parties and others (e.g., Courts, Agencies, etc.). In fact, no single entity has heretofore built an infrastructure that truly and squarely addresses and solves the aforementioned problems.

Thus, there exists a serious need for new and improved systems which will permit Internet systems and technologies to evolve to permit network users to engage in online processes that facilitate disposition of transactions and disputes occurring in the non-online world. Such new and improved systems must be easily configurable to facilitate transaction processing and disposition based on the very nature of the multitude of transactions that take place (e.g., inter-parties transactions, ex-parte proceedings, etc.). To be viable, such new and improved systems must interface with legacy systems to facilitate wide acceptance and use without disrupting or drastically changing the ways people transact their business and carry out their affairs.

The present invention solves the aforementioned problems and provides such new and improved systems and methods for facilitating transaction processing and disposition via a global network such as the Internet which are discussed in detail below.

### SUMMARY OF THE INVENTION

The present invention addresses the aforementioned limitations and deficiencies of the current state of the Internet to solve the above-described problems and provides new and improved systems and methods that facilitate transaction processing and disposition within an access controlled environment. The present invention takes advantages of open-standards based technologies and combines and improves upon the same to permit multiple parties to a transaction such as a lawsuit or other dispute to more efficiently communicate with each other, share information related to their transaction, communicate with decision makers directly, and obtain access to tools (e.g., settlement analytical tool, etc.) and services (e.g., expert referral services, court reporting services, document production services, etc.) that help them make better informed decisions—all without requiring such parties to leave their desks and without requiring costly, inefficient court or other similar appearances. And since transaction communications occur within an access controlled environment in which security may be based on user-defined levels of security, parties are assured of confidentiality, validity of stored data, and authenticity based on standards for the same. Now, parties to transactions may seek final resolution and settlement of their affairs online and via the Internet. In sum, the present invention creates a specialized network linking clients and related parties, attorneys, insurers, decision makers such as Judges, arbitrators, and mediators, and service providers that facilitates transaction processing and disposition online.

Certain key benefits are provided to parties as a result of the present invention. For example, litigation type transactions can now be brought to conclusion much faster and more cost effectively than conventional courthouse processing. Parties to deal type transactions (e.g., contracting arrangements, due diligence operations, etc.) close faster and more cost effectively as parties to such transactions can have faster access to deal documentation through use of centralized work and storage spaces. Parties to transactions can realize improved results for settlement and negotiations as settlement analytical tools and other resources are centrally available and readily accessible within a secure access controlled environment. In-house (company) counsel often responsible for overseeing outside counsel in the context of lawsuits, for example, now have improved systems for monitoring the costs associated with outside counsel operations, for communicating and sharing information with outside counsel, and for providing access to libraries of information and documents (e.g., forms libraries, etc.) thus resulting in ultimate cost savings. And, in terms of attorney-client relationships that are fully supported within the present invention, clients are assured of more efficient representation and expected levels of confidentiality.

Law firms and service providers benefit from the present invention by realizing lower costs associated with establishing and maintaining data processing platforms as they can now outsource such tasks to a centralized, specialized service provider. And, since a specialized provider operates the network in which the present invention resides, that service provider will be responsible for maintaining state of the art facilities, thus relieving parties from having to constantly update their platforms. And, since all law firms and service providers regardless of size have access to the service provider that operates the specialized network, the present invention has the effect of bringing otherwise unavailable technologies and services to a wider base of users thus leveling the playing field in the legal community.

The present invention solves the problems mentioned above in the background section of this patent document and delivers the benefits stated herein by providing a system and method for facilitating processing and disposition of a transaction (e.g., a dispute, lawsuit, components of the same, etc.) within an access controlled environment. The system and method include and involve an access control facility, a transaction management facility, an authentication facility and a billing facility. The access control facility is accessible via a global data processing network and configured to maintain user information, and to permit or deny a user to enter an access controlled environment within a data processing environment and to perform user operations within the access controlled environment. The transaction management facility is operable within the access controlled environment, is coupled to the access control facility, and is configured to store and maintain transaction data based on the transaction, the user operations, and a security scheme. The authentication facility is operable within the access controlled environment and is configured to authenticate the transaction data based on an authentication scheme (e.g., rules of evidence, etc.) corresponding to the transaction. The billing facility is configured to consolidate data related to internal operations (e.g., modifying transaction data, making decisions based on the transaction data, etc.) performed by the access control facility, the transaction management facility, and the authentication facility to generate and process billing data and to send a billing notice to a responsible party via the global data processing network.

The present invention also provides embodiments of systems and methods for facilitating transaction processing and disposition within an access controlled environment that include and involve an access control facility, a transaction management facility, an authentication facility, a connectivity and communications facility, and a billing facility. The access control facility is accessible via a global data processing network and configured to maintain user information and to permit or deny users to login into an access controlled environment maintained within a data processing environment. The user information includes a profile relating to each user and each profile includes a user-specific level of security. The transaction management facility is operable within the access controlled environment, is coupled to said access control facility, and is configured to store and maintain data related to a transaction involving at least one of the users based on a predetermined security level to facilitate disposition of the transaction within the access controlled environment, and to determine accessibility related to the data for each user based on each user's profile. The authentication facility is operable within the access controlled environment and configured to authenticate the data related to the transaction based on a predetermined authentication level set to correspond to the transaction. The connectivity and communications facility is coupled to the access control facility, the transaction management facility, and the authentication facility. The connectivity and communications facility is configured to communicate (transfer data, send messages, emails, etc.) with the access control facility, the transaction management facility, the authentication facility, and external transaction party systems to facilitate disposition of the transaction based on the data stored and maintained by the transaction management facility. The billing facility is configured to consolidate data related to internal operations performed by the access control facility, the transaction management facility, and the authentication facility to generate and process billing data and to send a billing notice to a responsible party via said global data processing network.

And, according to another embodiment, the present invention provides a method for facilitating processing and disposition of a dispute involving a plurality of transaction parties within an access controlled environment, comprising the steps of: at an access control facility accessible via a global data processing network, creating and maintaining user security profiles related to the plurality of transaction parties; at the access control facility, permitting or denying a user to login into an access controlled environment maintained within a data processing environment based upon the user and at least one of the user security profiles corresponding to the user; if the user is permitted to login, at the access control facility, providing operative access to the user to a transaction management facility operating within the access controlled environment and configured to store and maintain data related to disputes; at the transaction management facility, permitting user to create, update and delete transaction data based on the dispute and a predetermined security level to facilitate disposition of the transaction within the access controlled environment; at an authentication facility, requiring the user to enter authentication data related to the transaction data in order to authenticate the transaction data based on a predetermined authentication scheme; at the transaction management facility, permitting the user to enter the authentication data; at the transaction management facility, notifying the user if a decision needs to be made based on the transaction data and/or the authentication data; at the transaction management facility, allowing the user to enter a decision in order to dispose of the dispute; at a communications facility, notifying the plurality of transaction parties of the decision via the global data network; at a billing facility, consolidating data related to internal operations performed by the access control facility, the transaction management facility, and the authentication facility; and at the billing facility, generating and processing the billing data and sending a billing notice to at least one of the transaction parties via the global data processing network.

The present invention is next discussed in detail with reference to the drawing figures which are first briefly described.

### BRIEF DESCRIPTION OF THE DRAWING FIGURES

The present invention is described in detail below with reference to the attached drawing figures, of which:

FIG. 1 is a diagram that illustrates the parties and structures that can now work together in accordance with the systems and methods provided by the present invention to facilitate transaction processing and disposition online such as via the Internet and WWW within an access controlled environment;

FIG. 2 is a block diagram that illustrates the logical nature of a service facility and the relationships between such a facility and the structures and parties shown in FIG. 1 that are realized within the systems and methods provided by the present invention to facilitate transaction processing and disposition online within an access controlled environment;

FIG. 3 is a system diagram that illustrates a connected networked data processing environment in which a service facility operates in accordance with a preferred embodiment of the present invention to facilitate transaction processing and disposition online within an access controlled environment provided by the service facility;

FIG. 4 is a block diagram of an automatic data processing system that may be configured in accordance with the present invention to operate as the service facility, user systems and other external systems shown in FIG. 3;

FIG. 5 is a block diagram that illustrates the logical components of the service facility shown in FIG. 3;

FIG. 6 is a data flow diagram that illustrates an exemplary flow of data among the parties, structures, and logical components shown in FIGS. 1-5 and, in particular, the flow of data in the context of what is called an “inter-parties” proceeding such as a lawsuit;

FIG. 7A is a flowchart that illustrates a method for facilitating disposition of a transaction online within an access controlled environment in accordance with a preferred embodiment of the present invention;

FIG. 7B is a continuation chart and, in particular, a detail chart of Step S702 shown in FIG. 7A;

FIG. 7C is the conclusion of the flowchart started in FIGS. 7A and 7B;

FIG. 8A is a flowchart that illustrates a specific method for facilitating disposition of a transaction such as a motion raised by a litigant (a transaction party) in the context of an inter-parties proceeding online within an access controlled environment in accordance with a preferred embodiment of the present invention;

FIG. 8B is a continuation chart of the flowchart started in FIG. 8A;

FIG. 8C is a continuation chart of the flowchart started in FIGS. 8A and 8B;

FIG. 8D is the conclusion of the flowchart started in FIGS. 8A, 8B, and 8C;

FIG. 9A is a flow diagram that illustrates a process for authenticating and verifying user identities so that such users can become transaction parties in the context of a preferred embodiment of the present invention;

FIG. 9B is a flow diagram that illustrates a process for authenticating and verifying user identities using customer support systems and processes so that such users can become transaction parties in the context of a preferred embodiment of the present invention;

FIG. 9C is a flow diagram that illustrates a process for issuing secure user identification cards (e.g., SecurID™ Cards) to be used to permit users to become transaction parties and to access an access controlled environment provided in accordance with a preferred embodiment of the present invention;

FIG. 9D is a flow diagram that illustrates a process for fulfilling a request for issuance of a replacement secure user identification card (e.g., SecureID Card) to be used to access an access controlled environment according to a preferred embodiment of the present invention;

FIG. 9E is a flow diagram that illustrates another process for fulfilling a request for issuance of a replacement secure user identification card (e.g., SecureID Card) to be used to access an access controlled environment according to another preferred embodiment of the present invention; and

FIG. 10 is a diagram known as a “site map” that lays out a preferred embodiment of an Internet accessible site that will permit transaction parties to engage in online operations related to a transaction processed within an access controlled environment according to a preferred embodiment of the present invention.

### DETAILED DESCRIPTION OF THE PREFERRED EMBODIMENTS

The present invention is now discussed in detail with regard to the attached drawing figures which were briefly described above. Unless otherwise indicated, like parts and processes are referred to with like reference numerals.

Definitions

In the context of the present invention, the following terms set off by quotation marks shall have the following meanings:

The term “Transaction” means any type of interaction between people which requires final resolution (disposition). For example, a contract is a transaction that requires the parties to the contract to meet certain obligations or otherwise face certain defined consequences such as lawsuits for damages, etc. A contract may be one that binds parties to certain obligations of confidence—such contracts are often called “non-disclosure agreements.” Other transactions include inter parties litigations such as dispute in the context of a lawsuit between a plaintiff (a complaining party to a transaction) and a defendant (the party to whom a complaint is directed and who must answer a plaintiffs allegations which give rise to a lawsuit), arbitrations in which parties to a transaction may agree to be bound by an arbitrator's rulings as to the rights of contracting parties (e.g., as in the case of labor disputes and the like); settlement negotiations in which parties to a transaction may work directly with each other or otherwise involve negotiators, arbitrators, and mediators to help them reach settlement of a disputes; and ex parte litigation and processes such as in the case of transactions involving public and private disputes with organizations such as in the case of claims for social security benefits raised before the U.S. Government Social Security Administration and credit card charge disputes directly raised to one's credit card company. It is important to note that the term “Transaction” is an inclusive one in the sense that events occurring in everyday interactions between people may now be processed within the systems provided by the present invention. Moreover, a transaction in the context of the present invention may be recursive in that a transaction may include transactions which include transactions and so on, or, a transaction may spawn additional autonomous transactions. For example, a transaction such as a lawsuit may include subordinate transactions such as motions which occur during the disposition of the lawsuit, or a credit card dispute may spawn an additional transaction in the form of a lawsuit. And, despite the fact that the present invention may be utilized to facilitate efficient and effective disposition of a whole transaction such as a whole lawsuit, the present invention does not require complete processing to deliver its benefits; instead, a group of parties involved in a transaction (term: “Transaction Party”—defined below) may agree to access a service provided in accordance with the present invention to facilitate disposition of only a part of a transaction (e.g., a subordinate or, possibly, collateral transaction). Accordingly, it should be readily understood that a transaction may include, but certainly are not limited to, leasing transactions, contract type transactions, franchising transactions, licensing transactions, sales transactions, real estate transactions, Uniform Commercial Code (UCC) related transactions, non-disclosure agreement transactions, and all other interactions between people that require resolution and other similar management.

The term “Transaction Party” means any party including, but not limited to, individuals, organizations, public and private agencies and institutions, governmental organizations, Courts of law, etc. A transaction party may be a party to a lawsuit or be an entity responsible for providing an ancillary services such as a court reporting service in the context of a transaction such as during a lawsuit or other inter parties proceeding which is to be processed, at least in part, within an access controlled environment provided in accordance with the present invention. Transaction parties may or may not be actual, real parties in interest as that term is used in legal contexts; instead, a transaction party may be a Judge's clerk who is responsible for acting on behalf of the Judge in interacting with other transaction parties to resolve, for example, an online based motion.

The term “Access Controlled Environment” means an environment provided and operated within a data processing system or environment in which transaction parties communicate to resolve or otherwise dispose a transaction. An access controlled environment is one that exists as a state within a data processing system or environment. Transaction parties may safely and securely exchange information and data with other transaction parties within an access controlled environment.

The term “Service Facility” means an automatic data processing system and environment such as one that includes one or more automatic data and computing systems which has been configured in accordance with the present invention to facilitate transaction processing and disposition within an accessed controlled environment via a global network such as the Internet.

The term “online” means operations and processes that occur via a network communications link. Although the term “online” includes operations occurring via the Internet and WWW, “online” is not so limited. Instead, a process that can be carried out online in accordance with the present invention may be one that is performed completely outside of a publicly accessible network (e.g., the Internet and WWW), such as within an organization or among dedicated networks operating for the benefit of a particular group of organizations.

The description that follows is broken down into two primary sections: The first section is directed to the structural aspects of the present invention and outlines the structural features of the present invention that are used within an automatic data processing environment such as one that is coupled to the Internet and WWW to facilitate transaction processing and disposition online within an access controlled environment. The second section is directed to the operational aspects of the present invention that are used to facilitate such transaction processing and disposition.

Structural Aspects of the Present Invention

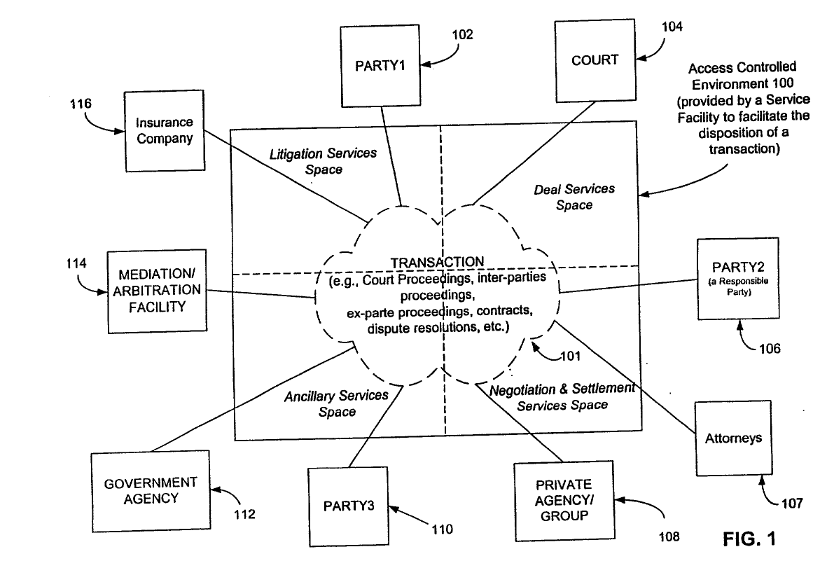

Referring now to FIG. 1, depicted therein is a diagram that illustrates the parties and structures that can now work together in accordance with the systems and methods provided by the present invention to facilitate transaction processing and disposition online within an access control environment. In particular, the structures shown in FIG. 1 include systems and objects within a data processing environment such as a modern network data processing environment that is coupled to the Internet and WWW. In particular, FIG. 1 depicts a plurality of transaction parties 102 through 116 including, but not limited to, party1 102, a Court such as a United States District Court 104, party2 106, a private agency or group 108, party3 110, a organization 114, attorneys 107, and an insurance company or carrier 116. As shown in FIG. 1, the rectangular structure is intended to identify an access controlled environment 100 which is provided by a service facility to facilitate transaction processing and disposition in accordance with the present invention. A transaction is illustrated as a cloud object 101 in the center of the Figure and within access controlled environment 100, is to be operated upon and accessed by the exemplary transaction parties 102-116 within access controlled environment 100. In this context, a transaction may include, but is not limited to, Court proceedings, inter-parties proceedings, ex-parte proceedings, contract scenarios, dispute resolutions, etc.

Transaction parties 102-116 are permitted to access, create, and modify transaction data stored within access controlled environment 100 via online sessions such as those occurring over the Internet and WWW. Such sessions may be secure sessions involving security technologies such as encrypted web sessions (secure pages), digital certificates and signatures such as those issues by security agencies (e.g., VERISIGN, INC.), confirmation mechanisms such as those which utilize biometric data (e.g., fingerprint data, etc.). And, as discussed below with regard to the operational aspects of the present invention, such security may be provided in terms of the verification schemes used to verify and authenticate actual transaction data stored and processed with access controlled environment 100. Accordingly, those skilled in the art of online security will readily appreciate that technologies such as HTTF, PKI, SSL, token schemes, ACE/Server Technology, etc. may be used to facilitate secure communications. ACE/Server provides centralized, strong authentication services for networks, ensuring that only authorized users gain access to network files, applications and communications facilities. In conjunction SecurID® token technology, ACE/Server creates a virtually impenetrable barrier against unauthorized access, thereby protecting service facility 200 and its data resources from potentially devastating accidental or malicious intrusion. Additionally, systems and processes provided by security service providers may be utilized within the context of the present invention such as those provided and offered by VERISIGN, INC., CHOICEPOINT, and EQUIFAX. Such security also may be implemented using FOB technology such as is used with downloads to wireless devices (e.g., such as those devices enabled with Wireless Access Protocol (WAP) capability), etc. digital certificates, biometrics, tokens, etc.

Additionally, it should be appreciated that security within the context of the present invention may embody online and offline processes. For example, users may be required to contact live-operator assist centers to have user-identities verified prior to accessing, creating, or otherwise modifying transaction data.

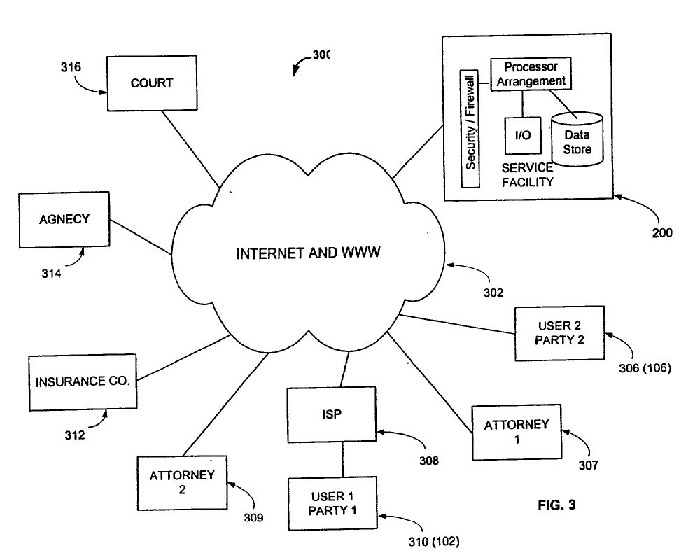

For purposes of illustration, Party2 106 has been designated as a responsible party—an entry that may be a transaction party that is responsible for interacting with a service facility (FIG. 3) on such issues as billing and the like for services rendered within access controlled environment 100.

All data and information generated and/or otherwise processed by transaction parties 102 through 116 may be centrally stored or stored in a distributed network environment but controlled within access controlled environment 100. Accordingly, party1 102 may be involved in a transaction such as a lawsuit against party3 110 which involves Court 104. The interactions between party1 and party3 and Court 104 may be recorded as data objects and stored for access within access controlled environment 100. Moreover, since access controlled environment 100 is configured within the context of the present invention to permit and deny user access to transaction data, such as Court proceedings, motions, etc., parties and, in particular, transaction parties can now utilize the present invention to gain immediate access to case relevant information and quickly and more efficiently than with previous systems and methods which often were paper based and riddled with inefficiencies. Access controlled environment 100 is the centralized environment and network which permits the present invention to facilitate transaction processing and disposition without the need for conventional systems and time consuming and inefficient processes.

Within the block that illustrates access controlled environment 100, are four (4) overlapping quadrants identified as the litigation services space, the deal services space, the ancillary services space, and the negotiation and settlement services space. Together such spaces within access controlled environment 100 provide an infrastructure that facilitates shared workspaces with secure communications to protect communications between transaction parties such as between attorneys and their clients (i.e., privileged attorney-client communications) attorney to attorney communications in the context of a settlement (i.e., privileged settlement communications), etc. Such shared workspaces within access controlled environment 100 can create a common standard for communications accessible to all permitted transactions parties based on access rights, matter types, data authentication levels, etc. The transactions processed within access controlled environment 100 possess high levels of security and process integrity which is achieved via electronic signatures of documents and other exhibits, data (e.g., documents, etc.) delivery verification between transaction parties, centralized preservation and storage of transaction data, and centralized management of transaction docketing and calendaring processes. Also, the present invention permits transaction parties to engage in party to party communications directly or indirectly.

It should be noted that the present invention permits transaction parties to be alerted of transaction data disclosures to other transaction parties, for example, based on established rules for disclosure which may vary based on transaction type, etc. Such rules may be based on logic that controls disclosure of transaction data such as rules based on real-world contracts, non-disclosure agreements, protective orders, and other transaction-specific rules or other proprietary rules prohibiting and/or allowing disclosure.

The litigation services space provides for secure communications between transaction parties thus assuring the protection of attorney-client communications, etc. Additionally, the litigation services space permits personalized case dockets for transaction parties involved in a particular transaction. Judicial decision making bodies (and other decision makers such as agencies, arbitrators, etc.) now have higher levels of participation within transactions which can now be handled online such as in the case of online-based hearings, motions, conferences among transaction parties, etc. And, since the access controlled environment is created based on and relative to a transaction, such a transaction can be initiated online such as through electronic filing and servicing processes provided by the structures and operations that make up the litigation services space. The litigation services space permits transaction parties to engage in a variety of operations that facilitate transaction disposition including, but not limited to, reviewing online forms banks (e.g., for review of prior filed and litigated briefs and decisions, etc.), receiving alerts about transaction events such as alerts that a judicial decision has been handed down via electronic mail, wireless communications, etc., and accessing transaction and matter docket data stored centrally or within systems that are permitted to be associated with access controlled environment 100. Accordingly, documents and other transaction data may be posted, changed, and modified in the context of a transaction within an access controlled environment. And, since the litigation services space is structured to be accessible within the common workspace provided by access controlled environment 100, transaction parties can now easily gain access to ancillary services which can be utilized to facilitate disposition of a transaction; such ancillary services include, but are not limited to, court reporting services, stenographic services, settlement algorithms and processes, duplication services, expert witness services, etc., and the product of such ancillary services are equally secure within access controlled environment 100.

In the deal space provided within access controlled environment 100, transaction parties can engage in secure communications to ensure privileged information, can engage in automatic and direct online filings of documents such as SEC documents, UCC documents, etc., and can engage in storage of transaction data for use by transaction parties without having to utilize conventional post and delivery systems and processes. In the deal space, transaction parties can review collections and libraries of forms which may be used to facilitate deal disposition, fill out the same and securely store and labeling such forms (bides, offers, settlement forms, etc.). Accordingly, it is a primary function of the deal space to permit access to transaction data, changes to transaction data, and to permit transaction parties to review transaction data. For, example, this patent document would be stored within the context of the present invention within deal space provided by the present invention.

It is important to note that transaction data stored within the deal space is so stored based on predetermined or user controlled data storage hierarchies (e.g., file and folder structures) established based on storage and retrieval requirements for a given transaction. Accordingly, transaction data for a real-estate transaction may include storage facilities (e.g., folders) for deeds, security interests, etc., while a non-disclosure agreement transaction may include storage facilities adapted to store disclosure materials, chain of custody data, etc. The present invention permits both the use of predetermined transaction data storage schemes (e.g., canned storage schemes), or user-defined schemes. And, a transaction party and a transaction may use a user-modified canned storage scheme to store and maintain transaction specific data. Accordingly, it should be immediately understood that transaction data may now be stored within a taxonomy that suits a particular transaction. The present invention supports data storage flexibility based on transaction needs.

In the ancillary services space, transaction parties have easy access to services that facilitate requests for proposal (RFPs) as commonly used in the corporate context, and other services such as expert witness referral services, court reporting services, continuing legal education services, travel planning services, personalized homepages for transaction parties and other registered system users such as those which may be accessible via the Internet and WWW, legal research services, billing and time keeping services, etc.

Accordingly, as all transaction parties can now interact with each other in an online environment such as via the Internet and WWW, greater communication will be realized between the people involved in a transaction. For example, clients such as insurance companies can now interact directly with their attorneys without anybody ever leaving their desks. Additionally, parties as well as transaction parties may now access Court, government and private agencies directly without the need for hiring experts and without engaging in time consuming processes and the like.

In sum, the access controlled environment 100 provided by a service facility in the context of the present invention now facilitates more efficient and less costly operations to facilitate the disposition of transactions utilizing modern technologies and communication vehicles such as the internet and WWW.

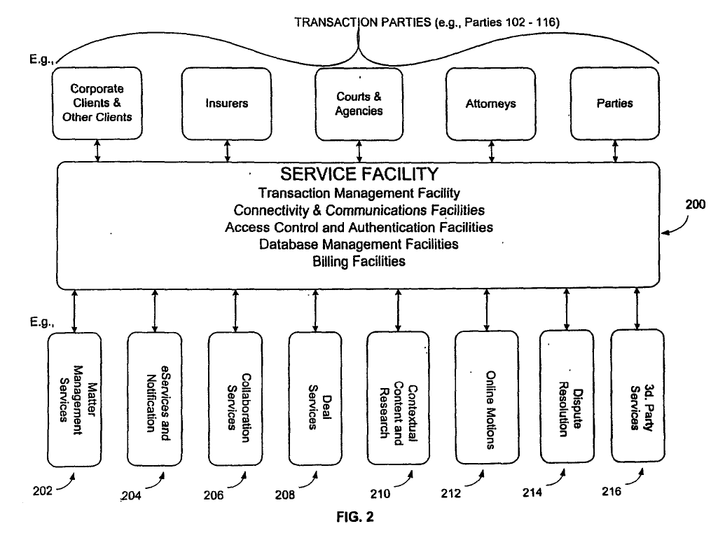

Referring now to FIG. 2, depicted therein is a block diagram that illustrates the logical structure of a service facility 200 and the relationships between such a facility and the structures and parties shown in FIG. 1. Additionally, FIG. 2 illustrates logical interactions that are realized within the systems and methods provided by the present invention to facilitate transaction processing and disposition online within an access controlled environment such as access controlled environment 100. In particular, service facility 200 is configured to provide access controlled environment 100. Service facility 200 includes structures to support a transaction management facility (a highly functional data management and processing facility), a connectivity and communication facility, an access controlled and authentication facility, data base management facilities and billing facilities. Such facilities are further described below with reference to drawing FIGS. 3 through 8D.

In FIG. 2, exemplary transaction parties of the type described with reference to FIG. 1 are shown across the top of FIG. 2. The flow of data and information such as motions to be filed (or actually filed) in a Court are indicated by the double-headed arrows between exemplary transaction parties identified as corporate clients and other clients, insurers, Courts and agencies, attorneys, and individual parties involved in a transaction.

Additionally, the services that may be carried out within access controlled environment 100 via service facility 200, include exemplary services 202 through 216 including, but not limited to, matter management services 202 electronic based services and notification 204, collaboration type services 206 such as collaborative work environment services, deal type services 208 such as services aimed at providing assistance during transaction processing such as analytical services, etc., contextual content and research services 210 such as provision of content and access to content services from content providers, online motions and filing services 212, dispute resolution services 214 such as arbitration and mediation services, and other third party ancillary services 216 (e.g., records management, witness referral services, etc.). For example, reporting services relative to a particular inter-parties proceeding may be provided by a Court reporter who would have access to access controlled environment 100. The data generated by such a Court reporter, would be processed, managed, and may be securely stored within access controlled environment 100 by service facility 200. As shown in FIG. 2, ancillary services are outside service facility 200 while within access controlled environment 100. However, the present invention is not so limited. For example, a portion or all of the ancillary services may be incorporated (i.e., executing within service facility 200) or alternatively, ancillary services may be offered by external systems (i.e., outside the access controlled environment 100) that are accessible and provide services within the access controlled environment 100.

Referring now to FIG. 3, depicted therein is a system diagram that illustrates a connected, network based data processing environment or system 300 in which service facility 200 operates in accordance with a preferred embodiment of the present invention to facilitate transaction processing and disposition within an accessed controlled environment provided by the service facility. In particular, in FIG. 3, system 300 includes a network data processing environment such as the Internet and WWW 302, server facility 304, user2 306, attorney1 307, an Internet service provider (ISP) 308, user1 310, attorney2 309, an insurance company 312, an agency 314, and another transaction party such as a Court 316 or other agency or decision making authority. The structures shown within system 300 may be interconnected via the Internet such as via modern telecommunications links, wireless links, and any other known and contemplated communications infrastructures. Such communications links and along with networking structures to facilitate the Internet and WWW will be readily understood by those skilled in the art. In particular, the open standards protocols used to facilitate network based communications such as TCP/IP and content rendering languages such as HTML, dynamic HTML (DHTML), JSP, JAVA, Javascript, Java beans, WAP (and other wireless technologies and protocols), along with security protocols such as secure socket layer (SSL) and other similar and like technical standards and technologies will be readily understood by those skilled in the art.

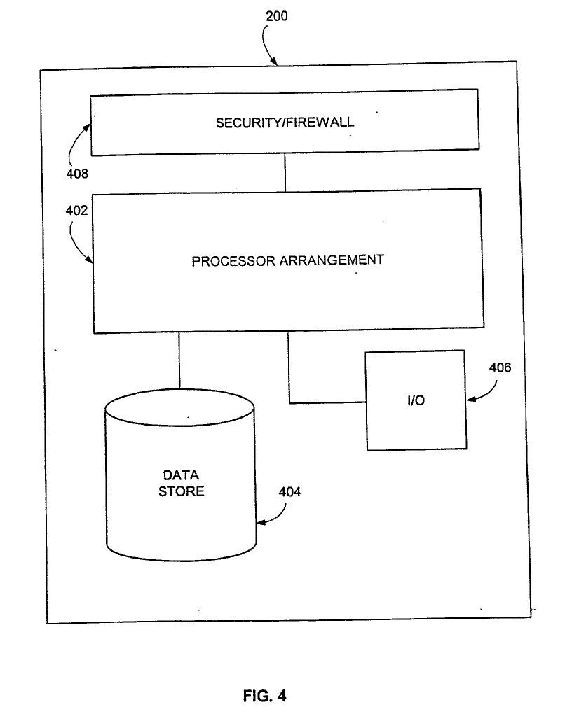

As shown within system 300, service facility 200 has an exemplary structure including a processor arrangement, input and output (I/O) facilities, a data store, and security and fire wall structures and technologies. Those skilled in the art will immediately understand the structure of service facility 200 especially in view of the structures shown in greater detail in FIG. 4 as discussed below. Service facility 200 is configured within system 300 to provide an access controlled environment and to facilitate the interaction of transaction parties in the context of disposing of transactions as discussed above with regard to FIG. 1.

More particularly, service facility 200 is a web-enabled server system that has been configured in accordance with the present invention to permit web access to access controlled environment 100 which exists as a state within service facility 200. Because service facility 200 is Internet accessible, it uses firewall technology and other similar and like technologies to avoid and secure against unwanted access and intrusion by hackers and other unauthorized personnel. A major security component of service facility is anti-virus security to ensure that transaction data stored within a data storage facility is protected from virus type intrusions. A preferred web-enabled, Internet ready platform suitable for instantiation of a service facility 200 includes data processing facilities such as those manufactured and marketed by iPlantet and SUN MICROSYSTEMS and runs the SUN SOLARIS operating system, ORACLE including the ORACLE APPLICATION SERVER, ORACLE DATBASE SERVER, access control facilities such as those implemented to utilized PKI and other security schemes compatible with RSA security processes. Additional service facility 200 will include firewalls, virus detection and processing systems and facilities, etc.

In system 300, user2 306, attorney1 307, an Internet service provider (ISP) 308, user1 310, attorney2 309, an insurance company 312, an agency 314, and another transaction party such as a Court 316 or other agency or decision making authority, or other agency or decision making authority, represent user systems and/or external systems that are used by transaction parties in order to access service facility 200 in order to facilitate the dispositions of a transaction. Such user systems or external systems may be, for example, conventional PC's executing a web browser with access to the Internet and WWW 302 wireless devices, personal digital assistants (PDAs), phones, NEXTEL type phones, and other similar and like communications and data processing devices, and/or other computer arrangements (e.g., web server facilities, application servers, etc.). Furthermore, such user systems and external systems may include back office systems, management systems, content retrieval systems, and other related data systems that may be used to facilitate disposition of a transaction.

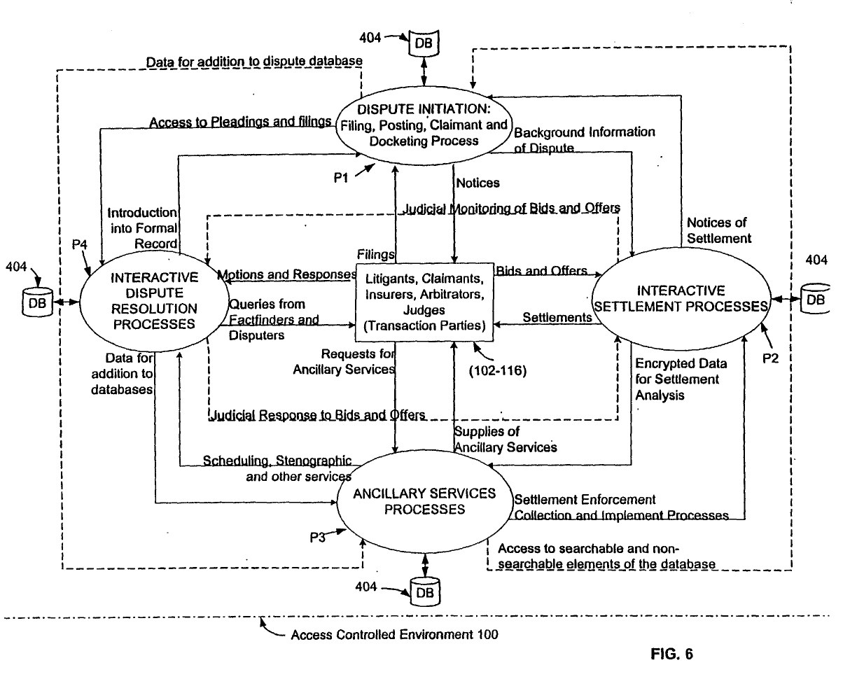

It is important to note that although system 300 includes one service facility, actual implementation of a networked infrastructure which is Internet and WWW accessible may be outfitted with more than one such service facility. Moreover, although service facility is shown as a separate component, such illustration is not intended to limit the scope of the present invention. To the contrary, those skilled in the art will readily appreciated that a distributed architecture could be used for such an accessible infrastructure. And, it should also be understood that a service facility of the type contemplated by the present invention may be implemented within a particular organization such as within a non-public network; in such a case, service facility 200 may be configured with the same open-standards based technologies and computer software to provide the same level of functionality as described below with regard to FIGS. 6-8D to facilitate transaction processing and disposition in a networked environment and/or in some other network type environment such as within a peer-to-peer network environment.

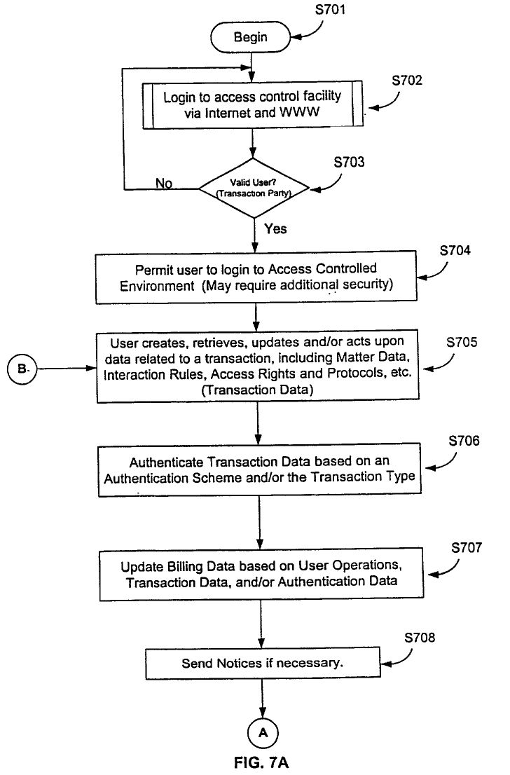

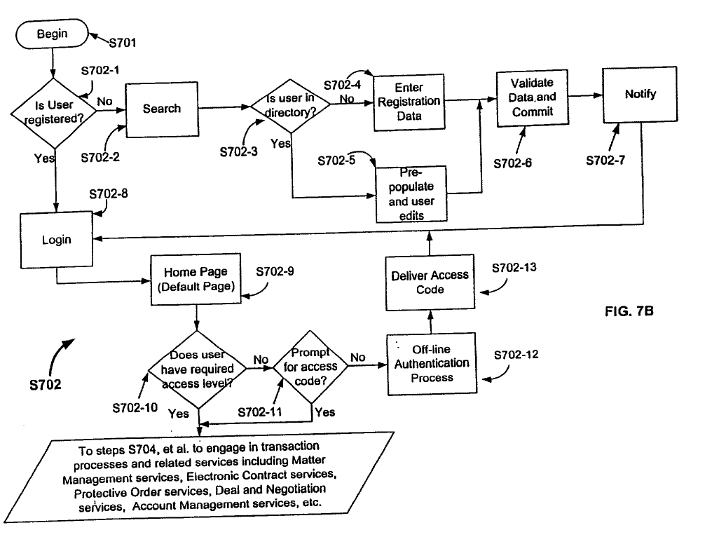

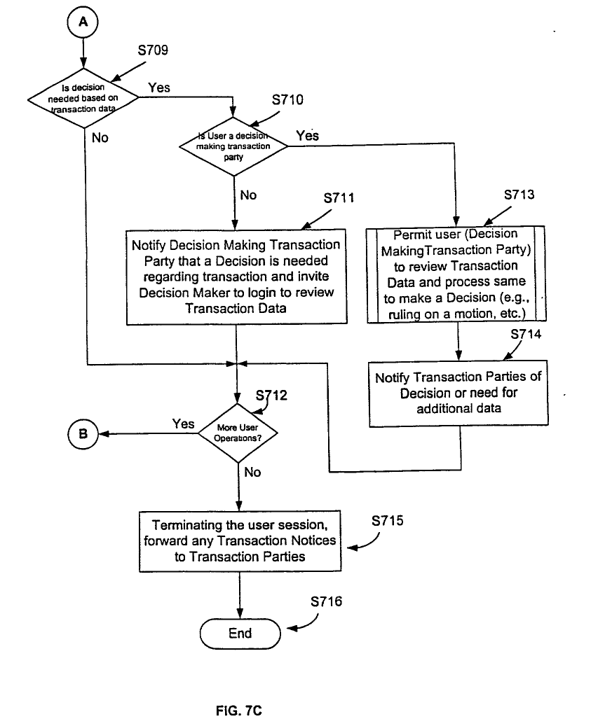

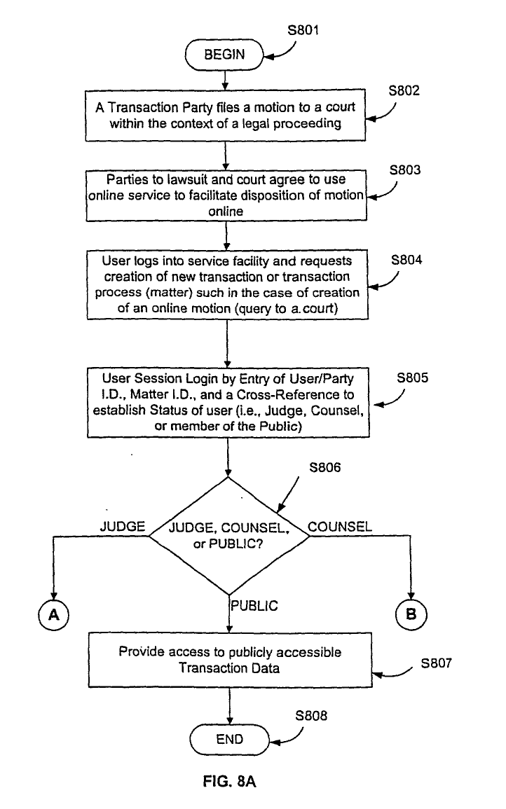

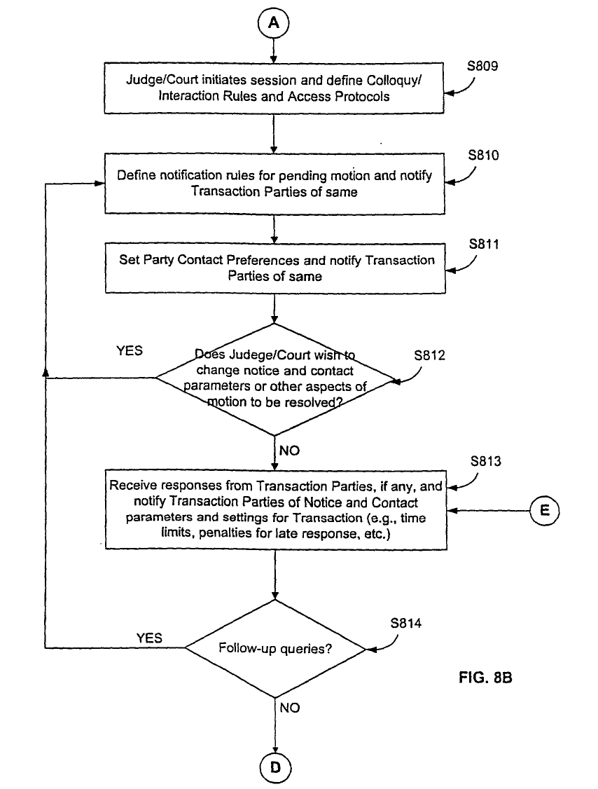

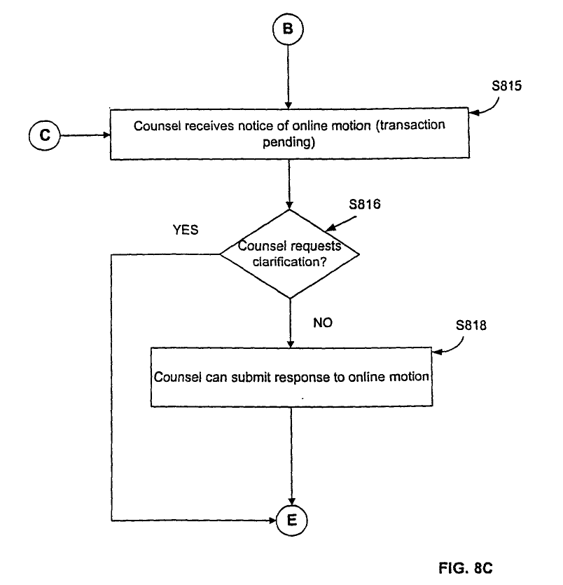

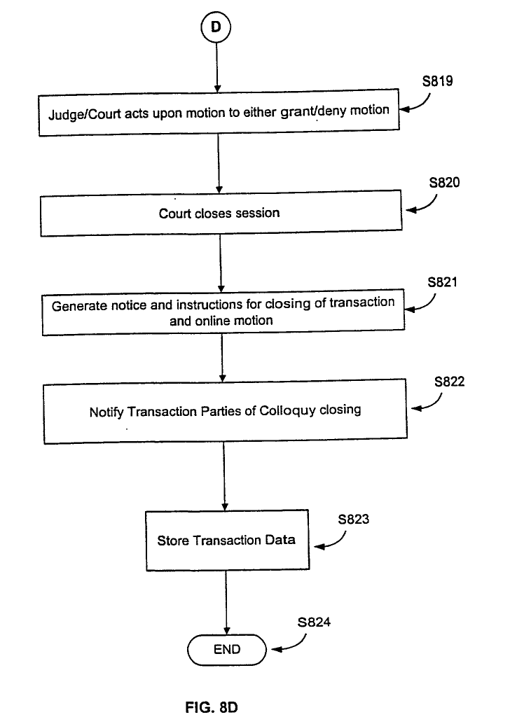

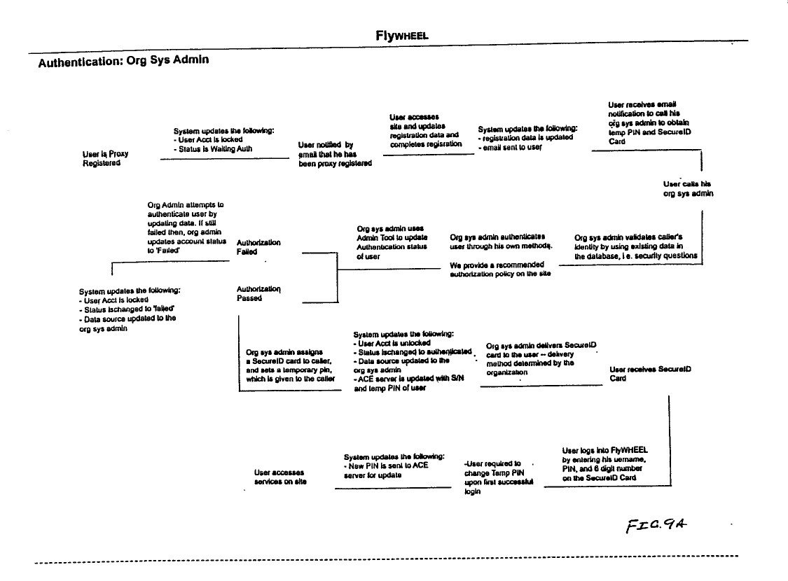

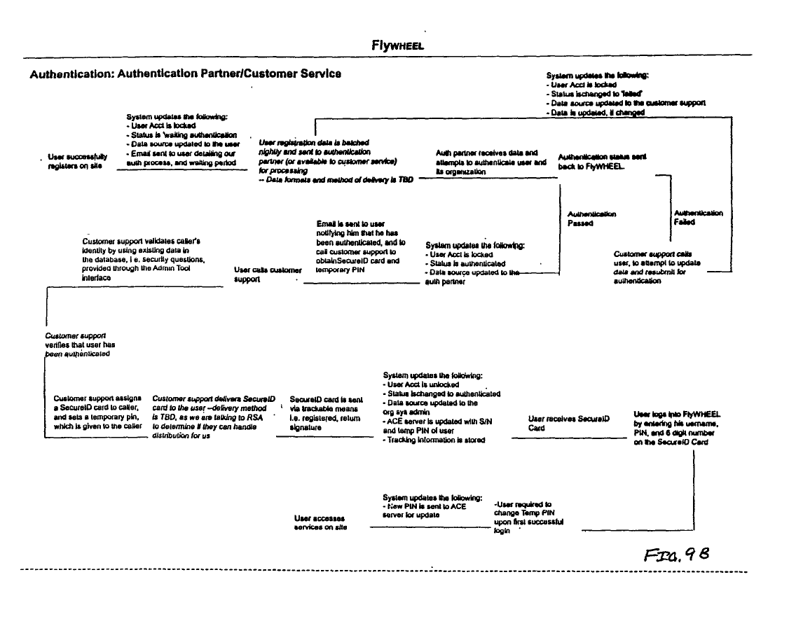

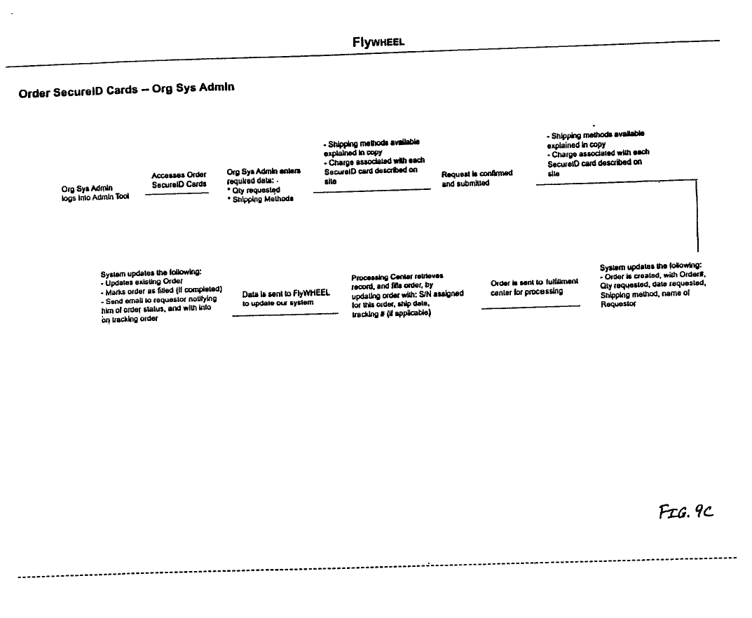

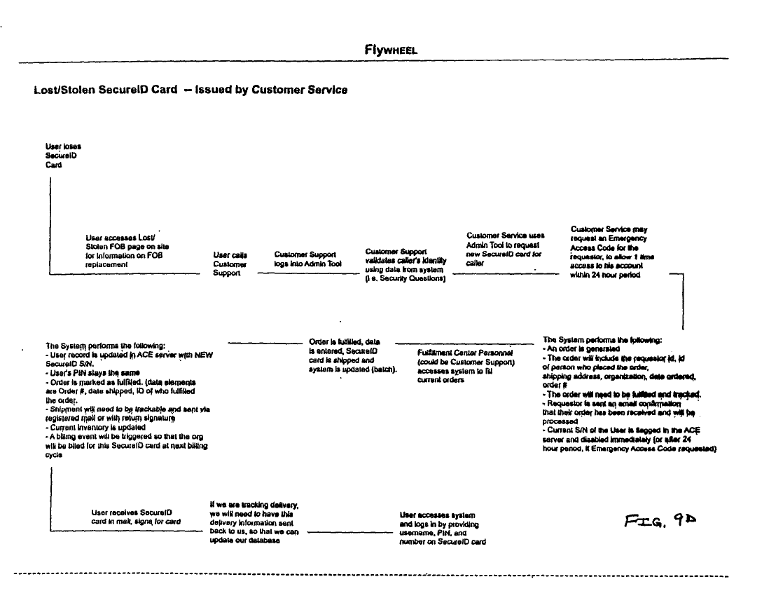

Referring now to FIG. 4, depicted there in is detailed block diagram of service facility 200 to clearly illustrate the data processing system nature of such a facility. In particular, service facility 200 includes a processor arrangement 402 including one or more automatic data processing systems which may be coupled together and/or otherwise linked to facilitate a data processing engine to operate in accordance with programmatic structures and the like and the type that are illustrated in FIGS. 7A-8D. Coupled to processor arrangement 402 are I/O facilities 406. Such I/O facilities 406 are configured to support network communications such as those carried out via defined protocols including, but not limited to, TCP/IP.

Also coupled to processor arrangement 404 is data store 404. Data store 404 is configured to support database management operations and to provide (along with appropriate database management software such as ORACLE V.x which is manufactured and marketed by ORACLE CORPORATION) the database management facility within service facility 200. The operations of such a database management facility are discussed in detailed below with regard to the flow charts identified in FIGS. 7A through 8D.

Also coupled to processor arrangement 402 are security and firewall structures and facilities 408 to prevent against unauthorized access to service facility 200. Such facilities enable service facility 200 to maintain a particular level of security to avoid unwanted access to data and, ultimately, transaction data within access controlled environments operated as states within service facility 200. Fire wall technology and other security mechanisms to prevent unwanted access to a controlled accessed environments may be hardware, software, or a combination thereof and, will be readily understood by those skilled in the art. Accordingly, security and firewall facilities 408 will permit system designers and implementers to implement systems and operations that permit users with valid ID codes, biometric attributes (finger print qualities, etc.), etc. to either be permitted to access the access controlled environment 100 (FIG. 1) or to be denied such access. Such security facilities may used by implementing RSA ACE Server and token technology, for example.

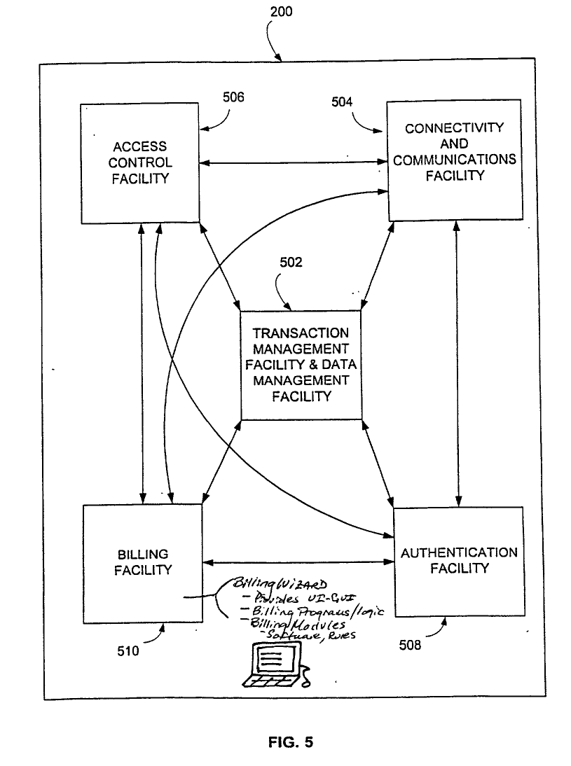

Referring now to FIG. 5, depicted therein is a block diagram that illustrates the logical components within service facility 200 as shown within FIGS. 2 through 4 to facilitate transaction processing and disposition online within an access controlled environment. In particular, and as noted above, service facility 200 includes transaction management facilities and data management facilities 502, connectivity and communications facilities 504, access control facilities 506, authentication facilities 508, and billing facilities 510. The logical constructs shown within FIG. 5 form the basis of the programmatic structures within service facility 200 used to facilitate transaction processing and disposition within an access controlled environment online such via a global network like or similar to the Internet and WWW. By way of example, connectivity and communications facility 504 may be used to communicate with transaction parties, user systems, external systems, other facilities within service facility 200, etc, such as via email, wireless means, TCP/IP and other communications protocols, etc.

Access control facility 506 is accessible via a global data processing network (e.g., the Internet and WWW) and is configured to maintain user information, and to permit or deny a user to enter access controlled environment 100 within a data processing environment such as service facility 200, and to perform user operations within the access controlled environment. Access control facility 506 is configured to permit or deny access based on user based parameters which designers and implementers may select based on desired levels of security and rules and regulations, privileges (e.g., attorney-client privilege, husband-wife privilege, etc.) and any other user-defined criteria. For example, such user based parameters may include, but are not limited to, personal and group passwords, personal identifiers (e.g., PIN codes), biometric data, etc. As such, access control facility includes technologies and programs to perform user session management, database connection management, etc. Such technologies and programs will be readily understood by one having ordinary skill in the art.

Transaction management facility 502 is a set of programmatic objects which are illustrated as sequence based operations with FIGS. 7A-8D that is operable within access controlled environment 100, which are coupled to access control facility 506 and which are configured to store and maintain transaction data in a variety of formats based on the nature of the transaction (e.g., database records, objects and/or files structured to store transaction data such as litigation data, namely, parties' names and profiles Judge and Court information, etc.) or the user's operations within access controlled environment 100, and/or a security scheme such as one calling for encryption or some other data based security scheme. Accordingly, transaction management multiple facility includes layers of security to ensure the proper level of controlled access to all transaction parties based on the transaction, dispute, state and status, party involved, type of transaction data being updated, added or deleted, and other parameters that may be set relative to the transaction.

Authentication facility 508 is operable within access controlled environment 100 and is configured to authenticate transaction data based on an authentication scheme corresponding to the nature of the transaction. Accordingly, authentication facility 508 may include structures, programs, etc. that allow additional data to be retrieved, stored and associated to transaction data in order to authenticate the transaction data.

Billing facility 510 is configured to consolidate data related to the internal operations performed by access control facility 506, transaction management facility 502, and authentication facility 508 to generate and process billing data and to send a billing notice to a responsible party (an entity responsible for paying for services associated with the operations of service facility 200) via the global data processing network (e.g., the Internet). Accordingly, billing facility 510 may include structures, programs, etc., that allow access to data achieves, billing schemes, user data, transaction data, etc., in order to generate such billing records and notices.

Accordingly, it should be appreciated that the present invention permits several layers of security relative to transactions that will be described in further detail below with regard to FIGS. 6 through 8D. And, the present invention's ability to allow transaction participants to select desired levels of security for application within the context of a transaction and, ultimately, within a corresponding access controlled environment stated within service facility 200 permits users the flexibility and provides assurances that data processed within a transaction is safe and secure, authentic, and generated by permitted users. Generally speaking, the present invention provides access control via granting access rights and allowing users to enter a collaborative workspace. Data security is achieved via security mechanisms including encryption and other similar and like digital security techniques. Data authenticity, a key component of the present invention, is achieved by permitting users to store data about data (i.e., meta data) to support a desired and/or expected level of authenticity. For example, a transaction party may operate within a transaction space and attempt to store a document in the context of a litigation being managed via service facility 200. In such a case, the document may need to be authenticated based on a known standard such as one articulated in the Federal Rules of Evidence (Article IX), in Title 18 of the United States Code (as used for Verifications and Statements by parties and witnesses), etc. A user can now be automatically prompted to enter additional data such as certifications of availability of original documentation, data about chains of custody about a piece of data, data about the location and possession of a piece of data, etc., in addition to other forms of meta data such as data tracking and access information, forensic data such as external data that tends to show the authenticity of the transaction data or of a user or some other parameter. Each additional piece of data may in turn require additional authentication. Such meta data may be stored so that a ruling party or decision maker may review the same to render a decision on the authenticity of transaction data. If an authenticity rule permits automatic evaluation, the present invention can be configured to automatically render decisions regarding authenticity based on meta data stored within data store 404.

Accordingly, the present invention permits users to select a particular level of security to suit a transaction based on a continuum of security including access security, data security, and data authenticity based not only upon forensic and tracking type data but also upon data that may be automatically requested relative to a particularly desired standard as defined by statute, rule, or process and the transaction parties.

The present invention's ability, among others, to allow users to select desired levels of security based on security continuum as described above and relative to the storage and management of transaction data clearly distinguishes itself from conventional workflow systems and arrangements wherein data may be verified by simply and automatically filling in fields without reference to established, external rules of validity such as those defined in the authentication rules of the Federal Rules of Evidence. For example, conventional workflow systems provide for only user level and data status level security. The present invention provides levels of security far above simple provide user level and data status level security and contemplates security based on digital security schemes and softer schemes required relative to transactions.

The double headed arrows shown within FIG. 5 clearly identify the flow of data and operations between the various facilities making up service facility 200. For example, access control facility 506 is configured to permit users and transaction parties to enter an access controlled environment such as access controlled environment 100 (FIG. 1). Such access may be associated with a particular service offering requiring the payment of a fee for each access to access controlled environment 100, as illustrated in FIG. 5 as the double headed arrow identifying data flowing to billing facility 510. The flow of data shown with FIG. 5 will be readily understood by those skilled in the art after reviewing this patent document and, in particular, the operations further described below with regard to FIGS. 6 through 8D. And, it should be noted that the flow of data within service facility 200 permits generation of substantial log and tracking data which may be used for billing purposes, auditing purposes, forensic purposes such as in the case of authenticating access, data validity, etc., and other management purposes to be defined by system designers and implementers. Such log and tracking data (meta data) may be used to manage transactions and groups of transactions within the context of the present invention.

And, finally, as the present invention contemplates a security continuum, so to does the present invention contemplate an anonymity continuum in the sense that a selected level of security may be desired such that the identity of a creator of transaction data may be set to remain anonymous to certain other transaction parties, completely, for a limited period of time, or based on some other criteria that suits the particular transaction. For example, in the context of a trademark dispute between transaction parties it may be necessary to invite members of the public to engage in an online survey whereby they respond to an online questionnaire—it may only be necessary to record the fact that distinct individuals participated in the survey and provided their responses. Actual identity of the survey participants may not be needed and/or desired. Service facility 200 can be configured with certification mechanisms to certify such levels of anonymity.

Operational Aspects of the Present Invention

The structures depicted in FIGS. 1 through 5 are configured to operate together to provide systems and methods for facilitating transaction processing and disposition within an access controlled environment such one accessible via a global network such as the Internet and WWW. Accordingly, reference is now made to FIGS. 6 through 8D to illustrate the operational aspects of the present invention, which facilitates such transaction processing, and disposition.

Referring now to FIG. 6, depicted therein is a data flow diagram that illustrates an exemplary flow of data among the parties, structures, and logical components shown in FIGS. 1 through 5 and, in particular, the flow of data in the context of an inter-parties proceedings such as a lawsuit. By way of example, a dispute such as a lawsuit is initiated within access controlled environment by processes identified as processes P1 through P4.

Once the lawsuit has been filed such as via electronic filing in accordance with the present invention, appropriate database records are created in data store 404 as those structural aspects exist within the litigation services space of access controlled environment 100 (FIG. 1). A litigant filing such a complaint within access controlled environment 100 may trigger the operations of interactive dispute resolution processes P2 by filing motions for Court action (e.g., a Motion to Compel Discovery). Such motions may be online motions as provided in accordance with the present invention. In response to such a motion, a decision making party such as a Judge may require the litigants to engage in settlement discussions which also may be carried out within the negotiation and settlement services space within access controlled environment 100 provided within service facility 200. Such settlement processes may be carried out by interactive settlement processes P3 within access controlled environment 100. The litigants (e.g., transaction parties) may be required to engage the services of expert witnesses, settlement and analysis tools such as what-if tools, etc., thus, engaging the ancillary services processes available within the ancillary services space within the access controlled environment 100 (FIG. 1).

As shown within FIG. 6, access controlled environment 100 permits transaction parties to engage in a host of operations and processes involving the litigation services space, the deal services space, the negotiating and settlement services space, and the ancillary services space illustrated in FIG. 1 as provided by the structural and logical features of the present invention as illustrated in FIGS. 2 through 5. The processes identified in FIG. 6 as processes P1-P4 are carried out within the logical construct shown in FIG. 5—that is, transaction management facility 502 includes a set of programmatic structures (as illustrated in the flowcharts shown in FIGS. 7A-8D) to facilitate such processes along with the other facilities making up service facility 200. Those skilled in the art will readily appreciate the flow of data identified within FIG. 6 and will understand the operations and processes that can result therefrom. It is important to note, however, that the operations carried out within access controlled environment 100 typically and normally relate to database operations as illustrated by the fact that the group of processes P1 through P4 interact with data store 404 as shown.

Referring to FIGS. 7A, 7B, and 7C, depicted therein is a flow chart that illustrates a method for facilitating disposition for a transaction online within an accessed controlled environment in accordance with a preferred embodiment of the present invention. In particular, processes and operations start step S701 and immediately proceed to step S702. At step S702 a user such as a transaction party can log into an access controlled facility via the Internet and WWW. Such an access controlled facility may be provided by service facility 200 as already described above with reference to FIGS. 1-5. The particular operations carried out at step S702 are further illustrated in FIG. 7B to which reference is now made.

In FIG. 7B, particular operations begin at step S702-1 where a determination is made as to whether the user is a registered user. If yes, operations and processes proceed to step S702-8 where the user is recorded as logged into service facility 200.

Next, at step S702-9, a service facility homepage is presented to the user via the internet and WWW such as via a web browser such as INTERNET EXPLORER V.x which is manufactured and marketed by MICROSOFT CORPORATION. MICROSOFT AND INTERNET EXPLORER are trademarks and/or registered trademarks of MICROSOFT CORPORATION.

Next, at step S702-10, a determination is made as to whether the user has a required access level (e.g., a set of access rights) to review information within an access controlled environment corresponding to a transaction or otherwise to access service facility 200. If so, operations return back to step S704, which is discussed below. If not, the user will be prompted online for entry of an access code or some other form of security pass at step S702-11.

At step S702-11, the user is prompted for an access code. If a valid access code is entered, operations return back to step S704 as discussed below. If not, operations proceed to step S702-12 to allow the user to engage in an offline security process such as one carried out with a customer service representative via telephone, via automated response systems, etc.

Next, at step S702-13 a valid access code will be delivered to the user and processing will proceed back to step S702-8 to allow the user to log into service facility 200. If at step S702-1 the user is determined to not be registered or their registration cannot be found within service facility 200, a search operation will be carried out at step S702-2, such as a database search against a user profile database within data store 404.

At step S702-3 an automatic determination will be made to determine if the user is in a directory of known users. If the user is in a directory, operations and processes proceed to step S702-5, wherein the user record will be repopulated and will be presented to the user for appropriate editing and correction of user data.

Next, processing and operations proceeds to step S702-6 where the data entered by the user for registration will be validated and committed to appropriate databases within data store 404. Next, at step S702-7 the user will be notified of his registration and will thereafter be permitted to log into service facility 200 and, ultimately, to an access controlled environment maintained therein.

If at step S702-3, the user is not found in a directory of known users, operations and processes proceed to step S702-4, allowing the online user to enter registration data and to thereafter have service facility 200 operate upon the same in accordance with steps 702-6 and -7, respectively. In any case, once a user has appropriately logged into service facility 200 and, possibly, to into a particular access controlled environment corresponding to a transaction, the user can engage in transaction processes and related services including matter management services, electronic contract services, protective order services, deal and negotiations services, account management services, etc.

Proceeding again within FIG. 7A, and in particular, at step S703, a determination will be made whether the user is a valid user in accordance with the operations discussed above with regard to FIG. 7B. If the user is not a valid user the login operations described above will commence again to either permit or deny the user to enter service facility 200. If the user is a valid user, operations and processes commence at step S704.

At step S704, the user is permitted to log into an access controlled environment and may be required to enter additional security information such as personal user identification information, biometric information, etc. Accordingly, a user session will be started such as by access control facility 504, and appropriate related systems operations are performed (e.g., database connection, queries, logging, etc.). Additionally, it should be noted that the user may be entering service facility 200 for the first time relative to a particular transaction thus enabling the user to create the transaction and, in turn, the access controlled environment for the same.

Next, at step S705, the user can create, retrieve update and/or act upon data related to a transaction including matter data, interaction rules, authentication rules as discussed above with regard to FIG. 5 (the security continuum), to access rights to certain data within an accessed controlled environment and to protocols related to the same. Such transaction type data is mentioned here for purposes of illustration and is not intended to limit the scope of the present invention.

Next, at step S706, transaction data operated upon or generated by the user may be authenticated based upon an authentication scheme and/or the transaction type as discussed above. For example, a user entering data related to document to be used as evidence within the context of a lawsuit type transaction may need to be authenticated based upon rules defined in the Federal Rules of Evidence. Although such determinations as to authentication and the like may ultimately require a decision maker to rule on admissibility and authenticity, the automated processes within service facility 200 are configured to prompt the user and, at least notify the user (such as via an online form presented via a WWW site) when additional authentication type information is required to authenticate a particular piece of evidence to be used within a particular transaction. Accordingly, the present invention now permits security to take on an additional level not heretofore contemplated by prior systems. That is, the present invention permits data to be verified against standards not relating to internal computing operations such as those used with security and encryption and the like. Now, transaction parties can ensure authenticity and validity of data stored within an access controlled environment provided within service facility 200 based upon standards that heretofore have been outside of the context of computing environments.

Next, at step S707, billing data within service facility 200 may be updated based upon, among other things, user operations, transactions data and authentication schemes used within an accessed controlled environment. Such data may be accessible from data achieve logs, tracking data, etc.

Next, at step S708, notices to transaction parties may be sent, if necessary. Already described above, a connectivity and communications facility may send an email notice, a system communication to an external system or user system, a facsimile notice, etc. Such a notice may contain any level of detail, or alternatively, may be vague of anonymous as required by the transactions.

Next, processing and operations proceed at the top of FIG. 7C and, in particular, at step S709 thereof.

At step S709, a determination will be made as to whether a decision is needed based upon the transaction data stored within data store 404 in context of a particular transaction. If a decision is needed, processing and operations proceeds to step S710.

At step S710, a determination will be made as to whether the user is a decision making transaction party such as a Judge, Magistrate, Agency Official, etc. If so, processing and operations proceed to step S713 where the user will be permitted to make or to review transaction data or to process the same to render a decision such as ruling on a motion, etc. Thereafter, processing and operations proceed to step S714 where the outcome of the decision will be transmitted to transaction parties along with requests for additional data and information, if necessary.

Next, processing and operations will proceed to step S712. At step S712, a determination will be made as to whether the user wishes to engage in additional operations that possibly may affect transaction data and the like. If not, the user session will be terminated at step S715 and any transaction notices will be sent to transaction parties if necessary. Operations will thereafter terminate at step S716.

If, at step S710, the user is not a decision maker, transaction processes and operations will proceed to step S711. At step S711, a notice is sent to the decision maker authorized to make a decision. As already described above, the notice may be sent any number of ways. Next, processing will proceed through the sequences beginning at step S712 through 716 as discussed above.

If at step S712, additional user operations are required and/or requested, operations will proceed at point B identified in FIG. 7A thus creating a looping structure beginning at the sequence step S705 as discussed above.

Referring now to FIGS. 8A through 8D, depicted therein is a flow chart that illustrates a specific method for facilitating initiation and disposition of a proceeding such as a court type motion or other proceeding raised by a litigant (a transaction party) in the context of an inter-parties proceeding such as a lawsuit, administrative proceeding, etc. online and within an access controlled environment in accordance with a preferred embodiment of the present invention. A typical online proceeding/motion contemplated by the present invention and which can now be processed within an access controlled environment is one that flows as follows:

A transaction party 1 is in a dispute with a transaction party 2. The transaction parties, counsel, and a Judge will have agreed to use service facility 200, for example, to process the dispute (at least to the extent of the online motion);

Transaction party 1 creates the motion within service facility 200 and, accordingly, causes creation of an access controlled environment;

The judge or decision maker is proxy registered and given admin rights to the access controlled environment;

The judge completes the registration process and is user authenticated. The judge can then add his clerks to the matter and specifies at least one clerk as an acting agent to the online transaction;

The judge's clerk sets up the motion by entering the motion name, the hearing date (if any) and selects which matter participants will be included in the motion and in correspondence from the court;

The judge then posts questions or other inquiries and specifies rules for response from transaction parties. Such rules may include word counts, time frames, exhibit rules, etc. The judge may specify questions and time frames in which to respond, along with penalties for not responding accordingly. The judge will be given a chance to review the questions, etc. to ensure for accuracy and the like;

Notifications about the judge's inquiries are sent to the transaction parties;

Transaction parties may respond to the inquiries from the judge and such responses will be posed within the access controlled environment;

Problems associated with transaction party responses are evaluated and noticed to the appropriate transaction parties (e.g., exceeding word counts, etc.);

A clerk or the judge may then cycle to post follow-up questions to the transaction parties, etc.;

The transaction parties may respond;

The court per a clerk, for example, posts motion status and results within access controlled environment (e.g., MOTION GRANTED, etc.); and

Notifications about motion status are sent to the transaction parties and a transcript will of the disposition of the online motion will be posted within the access controlled environment and, possibly, within publicly accessible storage.

The operations within an access controlled environment provided by the present invention as outlined above, are next discussed in greater detail with reference to the specific operations illustrated in FIGS. 8A through 8D. In particular, processing begins at step S801 and immediately proceeds to step S802.

At step S802, a transaction party files a motion (or some other similar or like document to initiate proceedings) to a Court (or other similar decision making body, etc.) within in the context of a particular legal proceeding such as within a lawsuit. A motion may include a request by a transaction party to compel discovery in the context of a lawsuit (e.g., a MOTION TO COMPEL), a request for an inter parties proceeding (e.g., a hearing) to seek court or similar decision making services or relief (e.g., a MOTION TO DISMISS a meritless lawsuit), etc. In this exemplary embodiment, the motion is filed in a conventional manner; that is, by way of paper motion submitted to a clerk's office of a court. However, if the parties and the Court agree ahead of time, such motion may be initiated online, such as already described above.

Next at step S803, the parties to the lawsuit and the Court agree to use service facility 200 to facilitate disposition of the motion/proceeding online and within an access controlled environment 100.

Next at step S804, a user logs into service facility 200 and requests the creation of a new transaction or transaction process, such as a matter such as in the case of creation of an online motion. It is important to note that at step S804 initial registration of an online matter requires the determination as to whether the user is already registered to act as a transaction party within access controlled environment 100, for example. Such operations were described above with regard FIG. 7A through 7C and are incorporated again here. If the user is a transaction party, then service facility 200, and in particular, access controlled facility 506, for example, will have on-file user name data, password data, the function role and affiliation of the user within the transaction, email addresses, physical addresses, BAR numbers in the case of attorneys, biometric identifiers, security Ids such as digital certificates and digital signatures which may be generated by certificate authorities such as VERISIGN, INC., lists known as buddy lists for correspondence with in an access controlled environment, telephone contact information, facsimile contact information, as well as any other information that system designers may deem appropriate. It is important to note that the user (if authorized; for example, an administrating party may be the only party authorized to set up process flows, security profiles, etc.) may specify certain security levels for access controlled environment 100. Such security may take the form of access control, data security such as that provided by encryption techniques, as well as authentication schemes which may be used to authenticate data within the transaction. Such authentication schemes were discussed above with regard to FIG. 5 and may include facilities and operations based upon otherwise external authentication techniques, such as those required by Federal Rules of Evidence, etc.

In terms of creating the transaction to be processed within service facility 200 and in the context of an accessed controlled environment such as accessed controlled environment 100, a matter may carry with it certain data including a caption of the litigation, short names of the litigation, case numbers and docket numbers, a name of a court or other adjudicating body, name of a decision maker such as the name of a Judge, lists of persons to be notified through a notification facility and accordingly, necessary information related thereto, as well as rules for updating the information stored for the matter. Such matter related transaction information is meta data in the context of the present invention and certainly represents significant transaction data that may be subject to security just like actual transaction data in the form of evidence and the like.

The setup of the transaction may occur as a result of action by a Judge or other transaction party or may be done automatically upon filing of a complaint in a courthouse, whereby the courthouse is setup to automatically create instances of transactions within service facility 200 which ultimately create corresponding access controlled environments maintained and managed by service facility 200.

Proceeding within the flow chart illustrated in FIG. 8A, and in particular, proceeding to step S805, the user will be identified in terms of his status as either a Judge or other decision maker, an attorney or counsel for a transaction party, or a member of the public.

At step S806, if it is determined that the user is a member of the public that user at step S807 may obtain access or may gain access to publicly accessible transaction data similar in nature to the type of data that may be issued by a courthouse in the context of public court records and the like.

Thereafter, at step S808, processing and operations end.

If it is determined at step S806 that the user is a Judge or other decision making transaction party, processing operations proceed at the top of FIG. 8B and, in particular, at step S809.

At step S809, a Judge or court or other decision making body initiates a session and defines colloquy and interaction rules and access protocols. In essence, the Judge sets the rules for the transaction but may later want to amend or modify them. For example, the Judge or court may set permissible word counts for online response by counsel and parties, the dates by which responses are due, the persons to whom the queries are directed, the extent of public access to the colloquy, the level security, security required within the transaction, whether the colloquy will be structured according to forms established by the court, for example, or one that that is set in an open form such as via online chat facility implemented within an accessed controlled environment, and the content of queries to and from the court. In particular, a Judge may specify that there are ramifications associated with going beyond certain word counts in a response to particular communications. This will have the affect of allowing a court or other decision making body to control the amount of content it receives thereby promoting efficient and articulate papers to be submitted within the context of a transaction. A Judge or other decision making body may define the consequences associated with having an over-long response, for example. Such over long response may be truncated, may require the payment of additional fees to court, or may be completely ignored based upon the fact that the response did not meet the length requirement. Such parameters may be used by the court, as noted above, to have parties be more articulate in the communications with the court. Additionally, by the court establishing specific rules for the timely filing of papers and the like, better communication is realized among all transaction parties within an accessed controlled environment. Rules my now be established based on specific matters and transactions as opposed to general court rules which may or may not apply in particular transactions. Accordingly, the present invention permits more efficient and effective communication between the decision making body and the litigants to a particular transaction.

In terms of public access to communications and transaction data provided within access controlled environment 100, the court may specify that the electronic communication shall not be viewable to the public over the Internet or through other electronic means and shall be accessible to the public only upon subsequent filing with the clerk of the court, or that the electronic communication shall be viewable by the public over the Internet upon the court's designation that is approved by the court, or that the electronic communications and responses shall be viewable within a publicly accessible area of access controlled environment 100 as soon as practicable once posted to the system. Of course other viewing parameters may be used to permit public access to court documents.

It is important to note, that the Judge may determine that certain levels of security are required for all other participants and transaction parties in the colloquy. For example, a Judge may require various combinations of passwords, secure identifiers, passwords and location identifiers, secure IDs based upon biometrics and the like, various methods of encryption, as well as other authentication type data as discussed above, such as that pertaining to external rules of evidence and the like.

Referring again to 8B, and, in particular, at step S812, a determination will be made as to whether the Judge or court wishes to change the notice and contact parameters or other aspects of the motion to be resolved. If that determination results in an affirmative answer, processing proceeds back to S810 thus creating a looping construct. Otherwise, processing proceeds at step S813.

At step S813, service facility 200, for example, will receive responses from the transaction parties, if any, and will notify the transaction parties of notice contact parameters and settings for the transaction (for example, time limits, penalties for late response, etc.)

Next at step S814, a determination will be made as to whether there are any follow up queries such as those by the court and/or the transaction parties which are involved in the transaction. If the determination at step S814 is affirmative, processing proceeds back to step S810 thereby creating a looping construct as discussed above. Otherwise, processing proceeds at the top of FIG. 8D as next described.

At step S819, the Judge or court will act upon the motion to either grant or deny the motion and will attempt to notify the transaction parties of the same within access controlled environment 100.

Next at step S820, the court will close the session and the transaction and then, at step S821, will generate notices and instructions for closing of the transaction and the online motion.

Next, step S822, service facility 200 will notify the transaction parties (e.g., via email, Facsimile (FAX), wireless communications (phone, pager, etc.) mail (POST), two-way pager, etc.) of the colloquy closing, and then, at step S823, will store transaction data which may include billing data and the like for later processing such as through use of conventional automated billing processes, data logging and tracking processes, etc.

Processing ends at step S824.

Referring again to FIG. 8A, if the determination at step S806 is that the user (transaction party) is an attorney for a litigant, for example, processing and operations proceed at the top FIG. 8C and, in particular, at step S815.

At step S815, counsel will receive notice of an online motion and that a transaction is pending within access controlled environment 100. Such notice my come in the form of a electronic communication, such as electronic mail (email), automatically generated notice via conventional post systems, wireless alert, or any other communications system established and coupled to service facility 200 which is configured to generate notices and to send the same to parties involved in a particular transaction. It is important to note that when communications mechanisms such electronic mail sent over the Internet are used to notify transaction parties of events occurring within an access controlled environment such communications may be formed according a predetermined level of vagueness. That is, while great lengths have been made to permit high levels of security (and anonymity) within access controlled environment 100, electronic mail sent from that access controlled environment may not possess the same level of security such as encryption, etc. Accordingly, such electronic communications (e.g., email) may merely reference that updates have been made to a particular transaction (such as via alias names for transaction to ensure attorney-client communications, privilege, and confidentiality, etc.) which may contain a code name established by a particular transaction party. There is no requirement that an email notification (or any other form of notice) contain any type of reference or direct reference to any particular piece of data or to a particular document stored within data store 404 within an accessed controlled environment maintained by service facility 200. All that is required within the present invention, is that transaction parties be notified that updates have been made and that their input and/or review is required or desired. Again, there is no requirement that any such communications contain any particular type of reference to any particular type of data or information within an accessed controlled stored within an access controlled environment. Also, such communications may be carried out in any particular order or fashion such as via cascading (Judge, Counsel, Clerks, etc.) and may be done automatically (passively) or upon express request for notice to be sent.

Next at step S816, a determination will be made as whether or not counsel for a transaction party or litigant in this case will request clarification of issues raised within the motion. If not, step S818 permits counsel to submit a response to an online motion online via the Internet and WWW by accessing access controlled environment 100 and having service facility and in particular transaction management facility 502 store the response within data store 404. Thereafter, processes and operations return back to step S813 as described above with regard to FIG. 8B.

If, at step S816, counsel does request clarification, processing and operations immediately proceeds to step S813 as discussed above with regard to FIG. 8B.

As has been discussed, the present invention provides new and improved systems and methods that facilitate transaction processing and disposition within an access controlled environment. The present invention takes advantages of open-standards based technologies and combines and improves upon the same to permit multiple parties to a transaction such as a lawsuit or other dispute to more efficiently communicate with each other, share information related to their transaction, communicate with decision makers directly, and obtain access to tools (e.g., settlement analytical tool, etc.) and services (e.g., expert referral services, court reporting services, document production services, etc.) that help them make better informed decisions—all without requiring such parties to leave their desks and without requiring costly, inefficient court or other similar appearances. And since transaction communications occur within an access controlled environment in which security may be based on user-defined levels of security, parties are assured of confidentiality, validity of stored data, and authenticity based on standards for the same. Now, parties to transactions may seek final resolution and settlement of their affairs online and via the Internet and WWW. In sum, the present invention creates a specialized network linking clients and related parties, attorneys, insurers, decision makers such as Judges, arbitrators, and mediators, and service providers that facilitates transaction processing and disposition online.

Certain key benefits are provided to parties as a result of the present invention. For example, litigation type transactions can now be brought to conclusion much faster and more cost effectively than conventional courthouse processing. Parties to deal type transactions (e.g., contracting arrangements, due diligence operations, etc.) close faster and more cost effectively as parties to such transactions can have faster access to deal documentation through use of centralized work and storage spaces. Parties to transactions can realize improved results for settlement and negotiations as settlement analytical tools and other resources are centrally available readily accessible within a secure access controlled environment. In-house (company) counsel often responsible for overseeing outside counsel in the context of lawsuits, for example, now have improved systems for monitoring the costs associated with outside counsel operations, for communicating and sharing information with outside counsel, and for providing access to libraries of information and documents (e.g., forms libraries, etc.) thus resulting in ultimate cost savings. And, in terms of attorney-client relationships that are fully supported within the present invention, clients are assured of more efficient representation and expected levels of confidentiality.

Law firms and service providers benefit from the present invention by realizing lower costs associated with establishing and maintaining data processing platforms as they can now outsource such tasks to a centralized, specialized service provider. And, since a specialized provider operates the network in which the present invention resides, that service provider will be responsible for maintaining state of the art facilities, thus relieving parties from having to constantly update their platforms. And, since all law firms and service providers regardless of size have access to the service provider that operates the specialized network, the present invention has the effect of bringing otherwise unavailable technologies and services to a wider base of users thus leveling the playing field in the legal community.

Exemplary processes for authenticating and verifying user identities are shown and now described with reference to FIGS. 9A, 9B, 9C, 9D, and 9E. Such process may be configured to utilize security cards similar or like SecurID™ type security cards such as those that operate in accordance with host and client synched security codes to facilitate verification of user identity. Such devices utilize synchronized codes which permit users possessing a valid code generated within an electronic credit card like instrument to be presented to a host system (e.g., service facility 200) to permit the user to enter a controlled data processing space. Beginning with FIG. 9A, depicted therein is a flow diagram that illustrates a process (referred to as FLYWHEEL™) for authenticating and verifying user identities so that such users can become transaction parties in the context of a preferred embodiment of the present invention. The FLYWHEEL™ trademark is a trademark of the owner of this patent document and any rights stemming therefrom. In particular, FIG. 9A shows a process wherein a user such as a transaction party may access service facility 200 and engage in a series of operations that ultimately may lead to issuance of a SecurID secure access card such as one that operates in accordance with host and client synched security codes. A SecurID token provides an easy, one step process to positively identify network and system users and to prevent unauthorized access. For example, when SecureID tokens are used in conjunction with other hardware or software access control modules (ACMs), including ACE/Server®, a SecurID token can generate a new, unpredictable access code every 60 seconds. The operations and process flows shown in FIG. 9A will be immediately understood and appreciated by those skilled in the art. It is important to note that references to “system” within FIG. 9A and progeny may be considered references to service facility 200, for example. The process flow shown in FIG. 9A, and progeny, is read left to right as will be readily understood by those skilled in the art.

FIG. 9B, similar to FIG. 9A, is a flow diagram that illustrates a process for authenticating and verifying user identities using customer support systems and processes so that such users can become transaction parties in the context of a preferred embodiment of the present invention. Here, a customer service facility and one which may include customer service personnel may be involved in the process of issuing secure access instruments like or similar to SecureID cards discussed above with regard to FIG. 9A.

Referring now to FIG. 9C, depicted therein is a flow diagram that illustrates a process for issuing secure user identification cards (e.g., SecurID Cards) to be used to permit users to become transaction parties and to access an access controlled environment provided in accordance with a preferred embodiment of the present invention.

Referring now to FIG. 9D, depicted therein is a flow diagram that illustrates a process for fulfilling a request for issuance of a replacement secure user identification card or other similar or like instrument (e.g., SecurID Card) to be used to access an access controlled environment according to a preferred embodiment of the present invention. Such a process flow may be carried out in the case that a transaction parties loses or otherwise misplaces, etc. a secure card.

Referring now to FIG. 9E, depicted therein is a flow diagram that illustrates another process for fulfilling a request for issuance of a replacement secure user identification card (e.g., SecurID Card) to be used to access an access controlled environment according to another preferred embodiment of the present invention. The flow of operations depicted in FIG. 9E will be immediately understood after careful review of the figure in view of the discussions found herein.

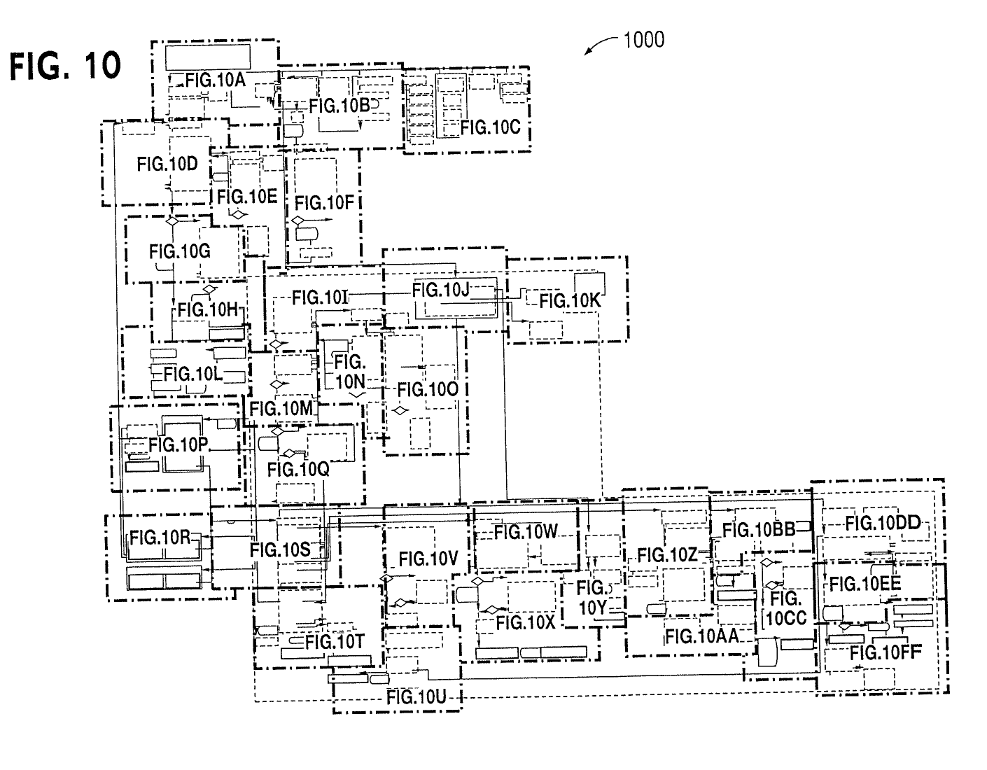

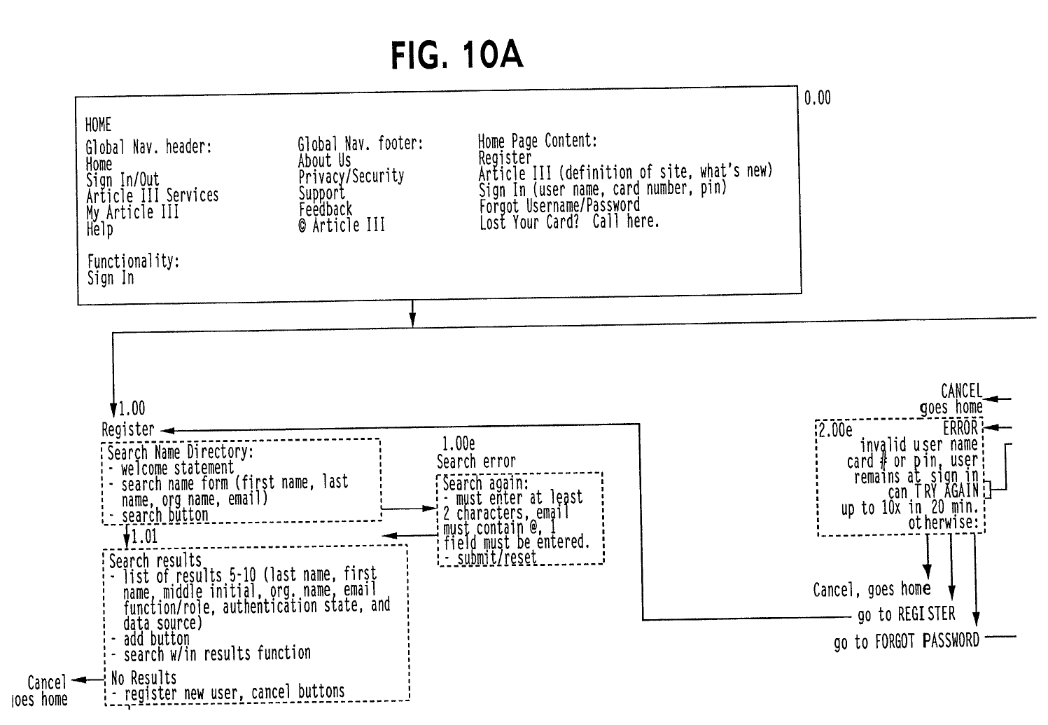

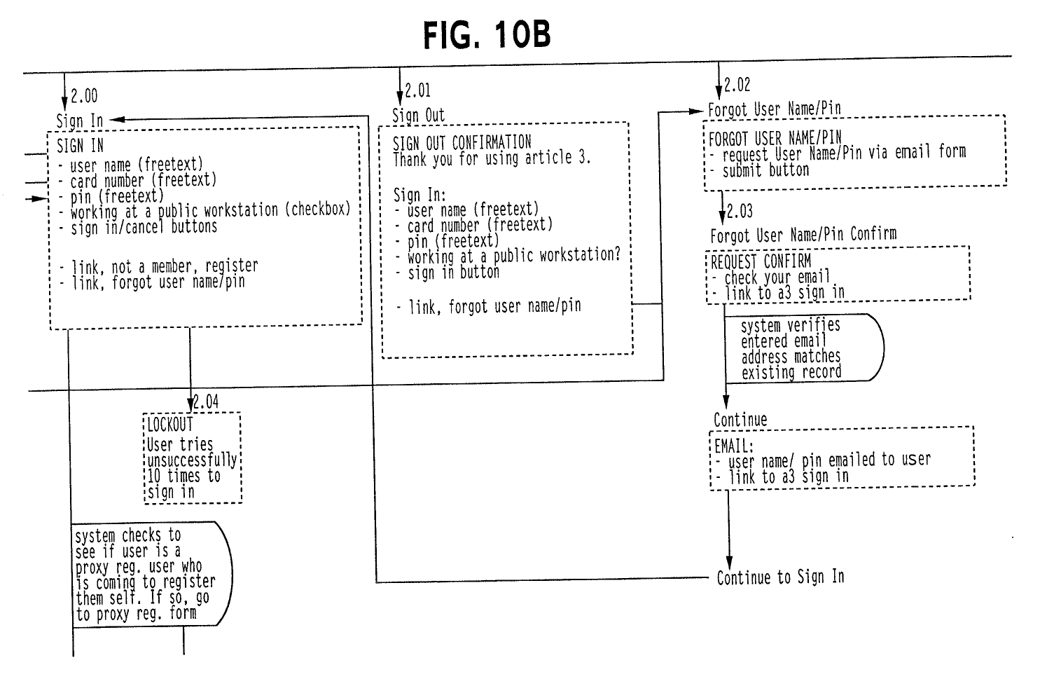

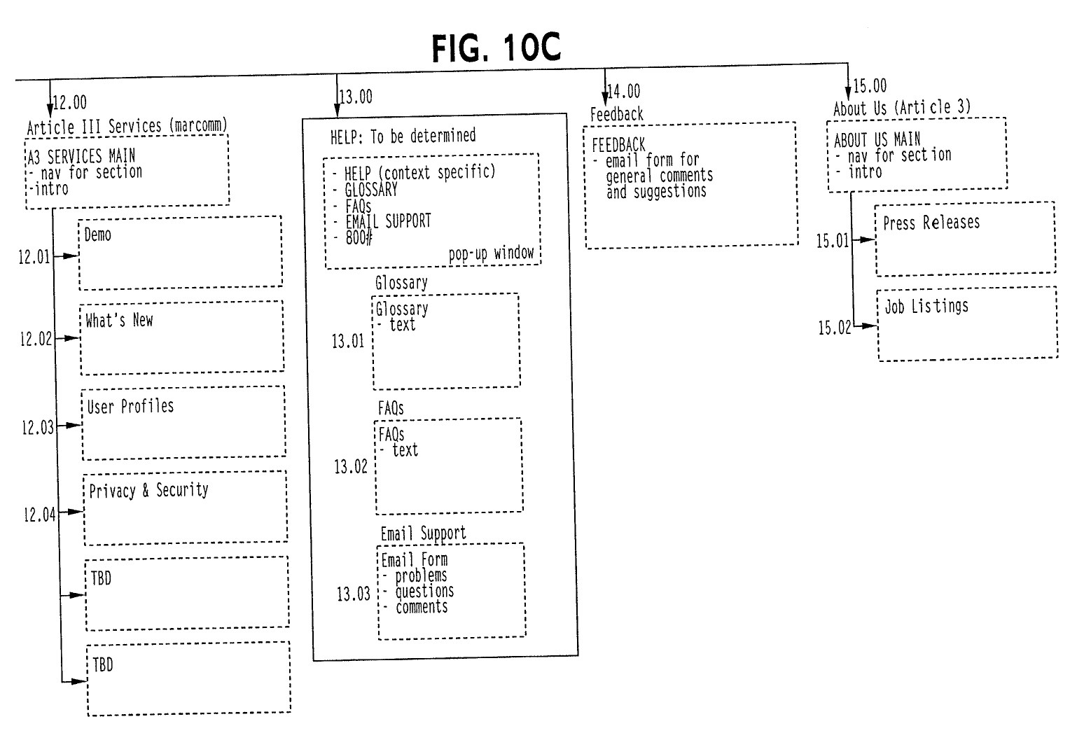

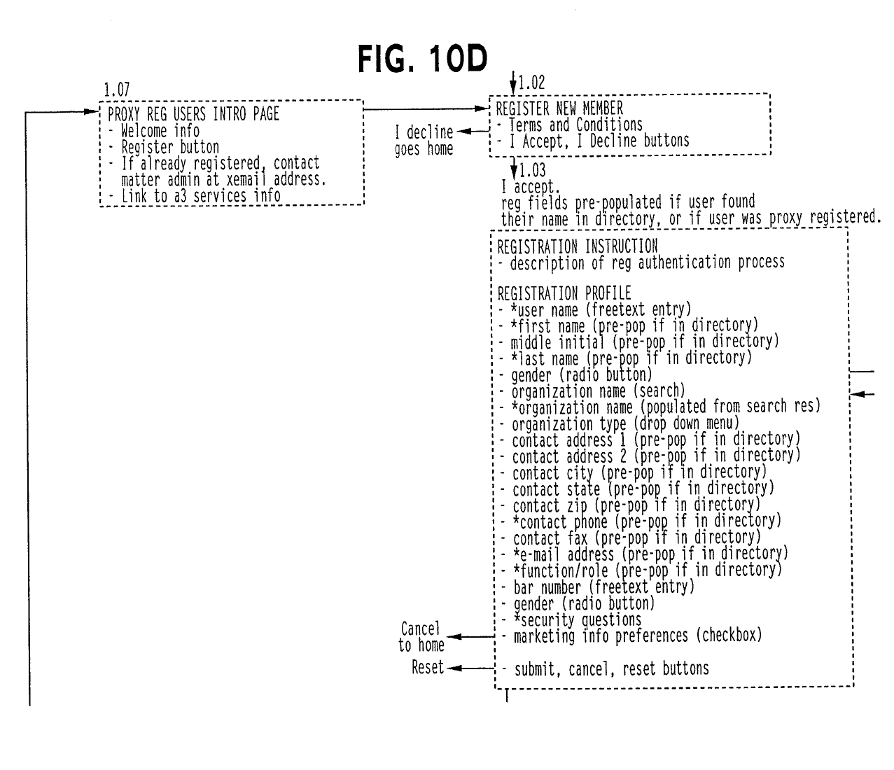

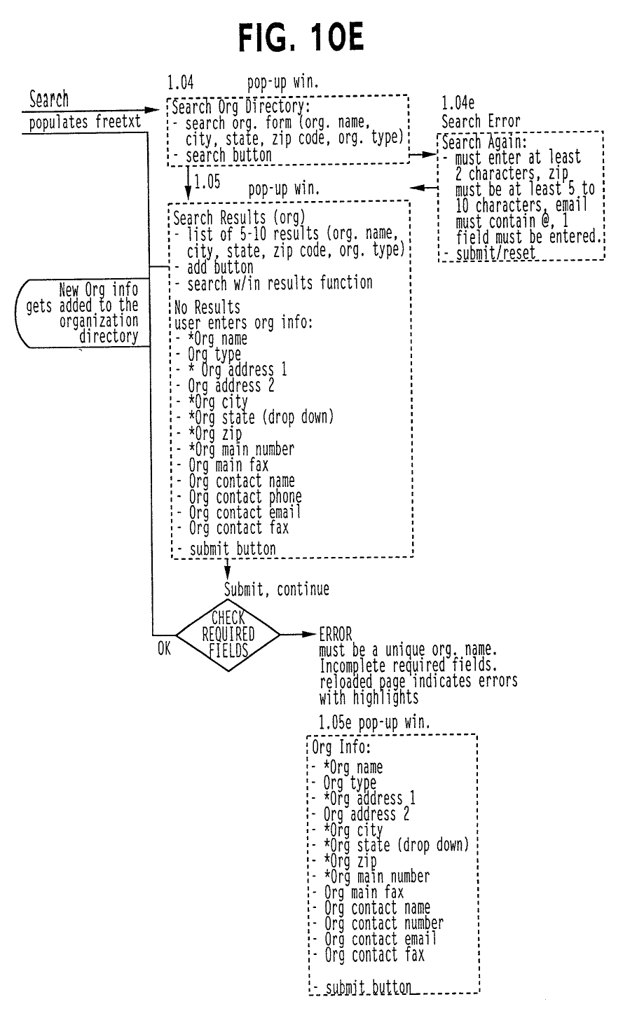

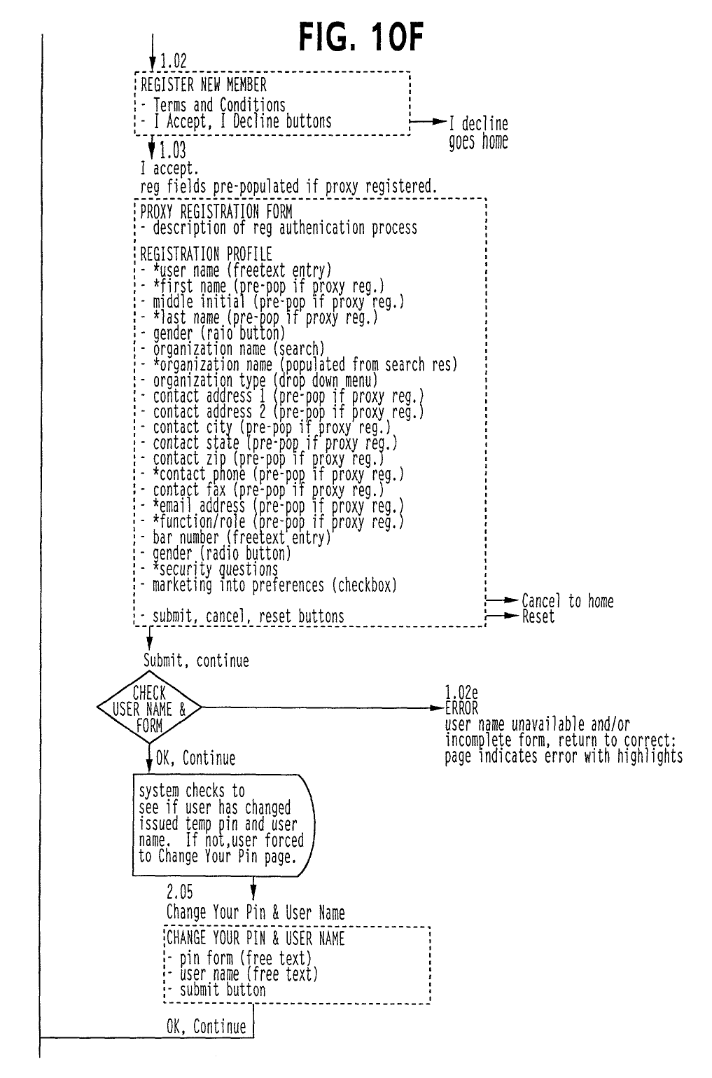

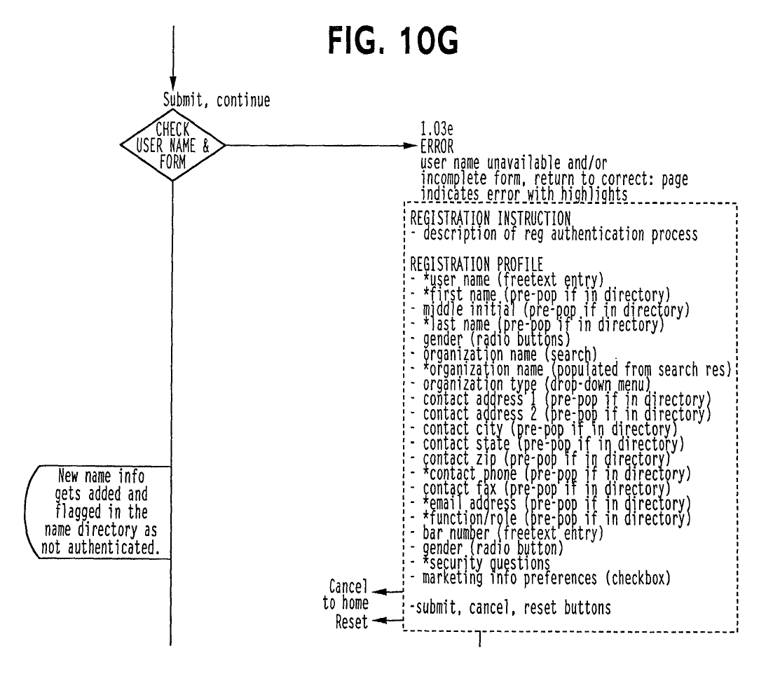

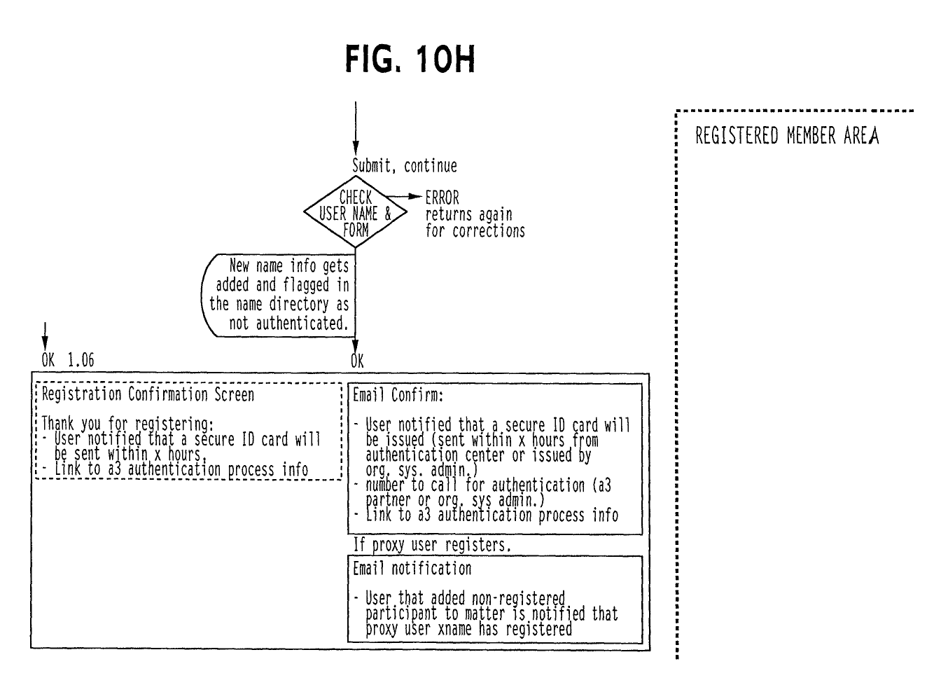

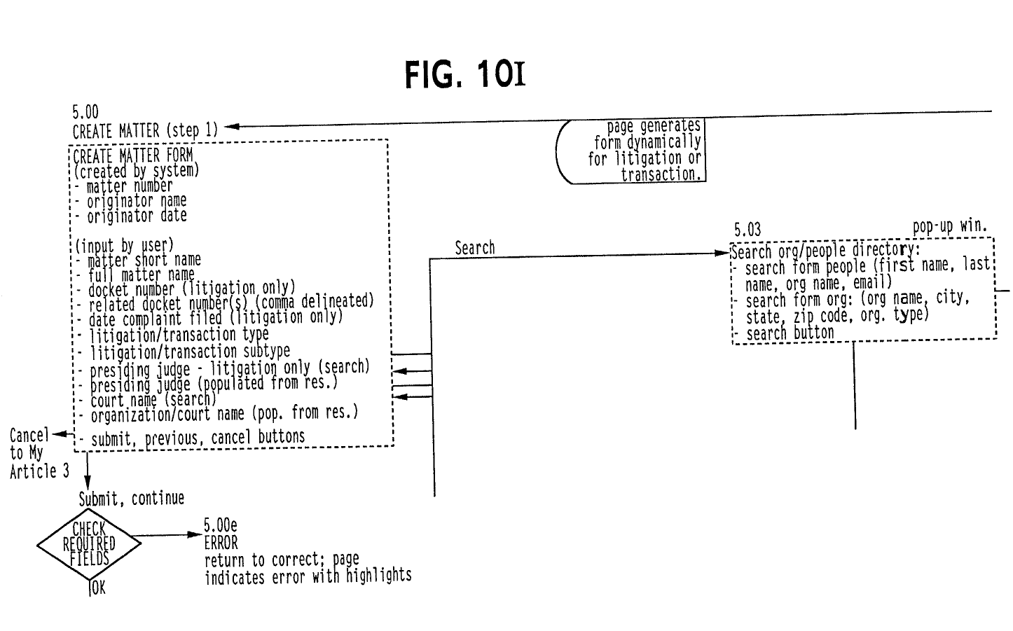

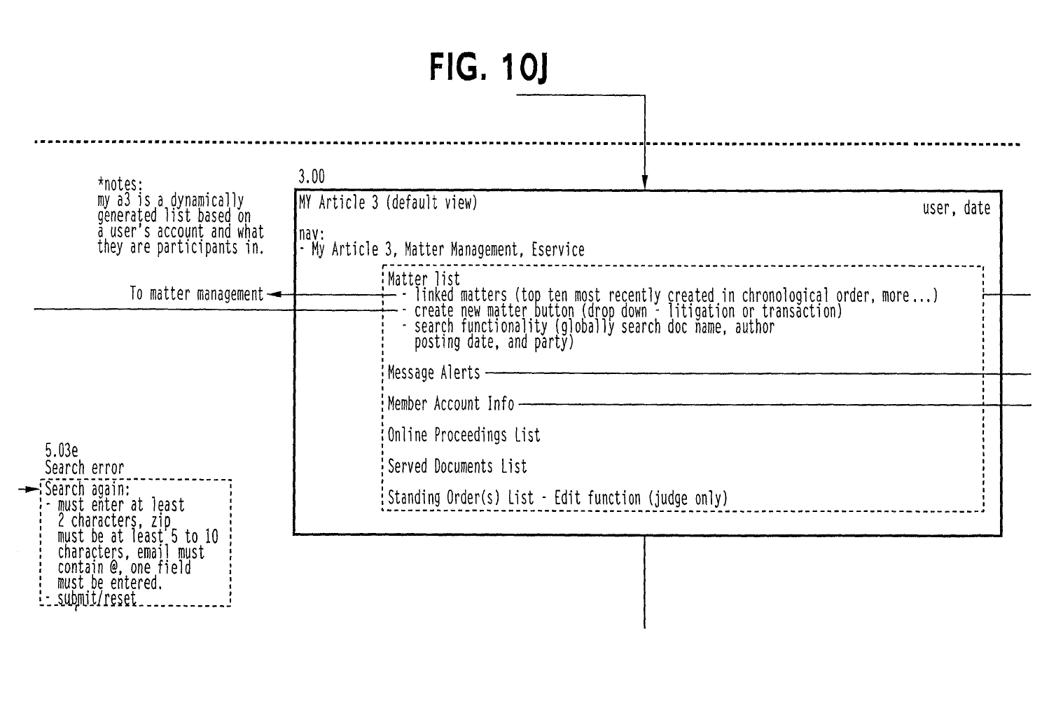

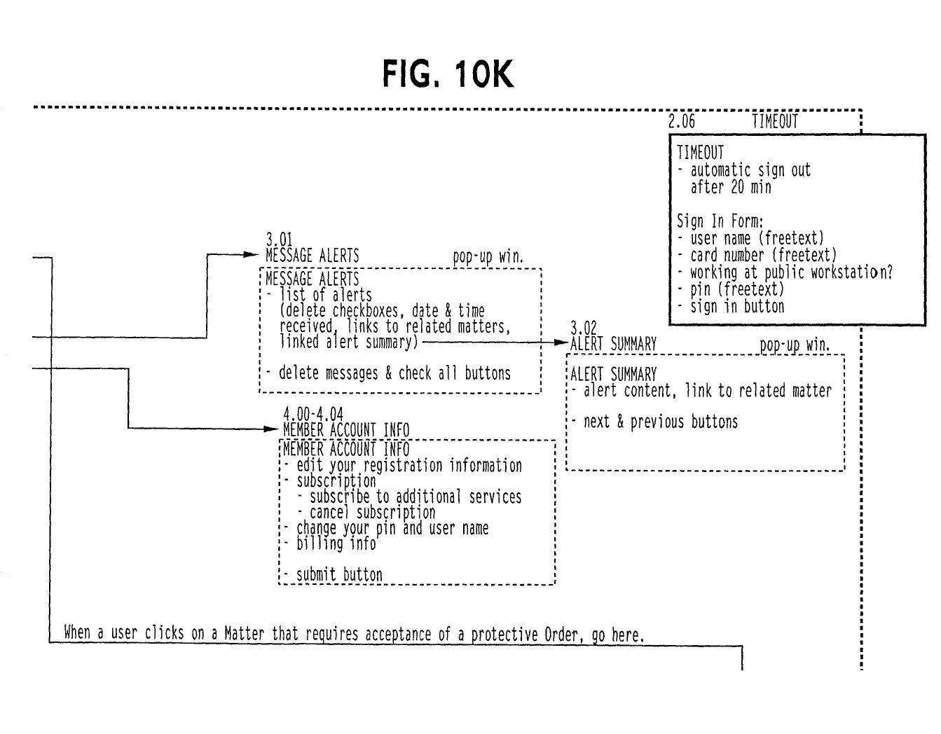

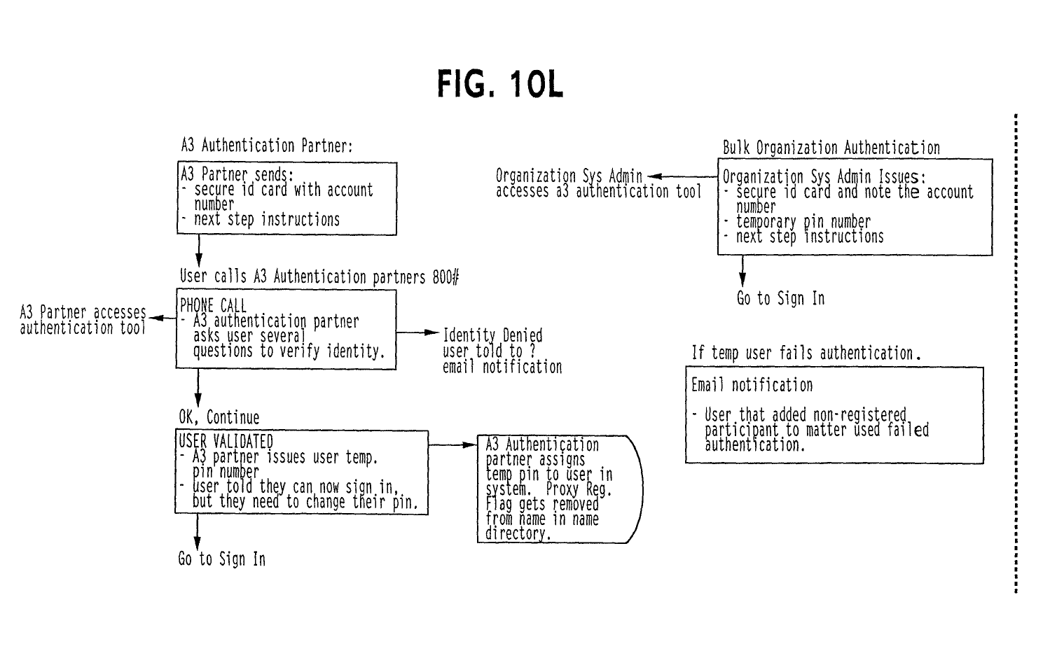

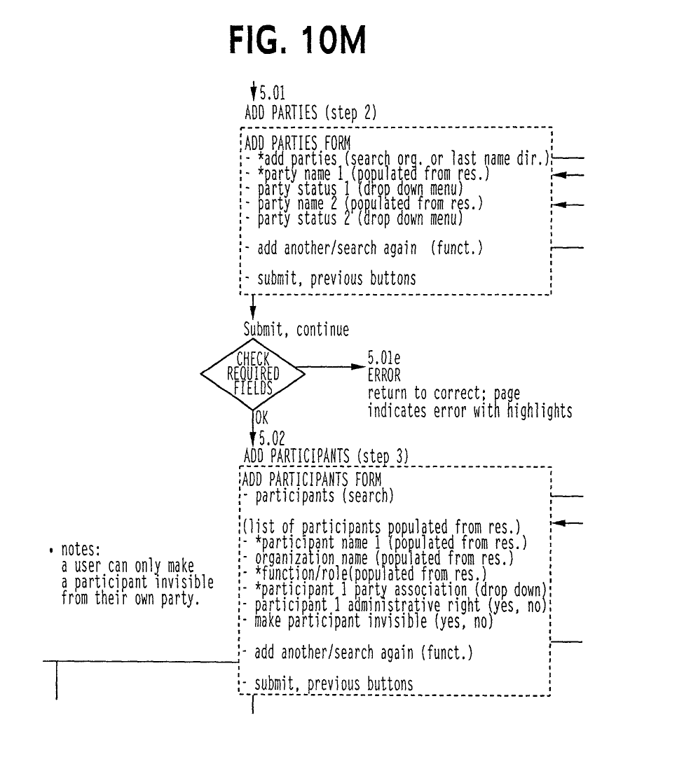

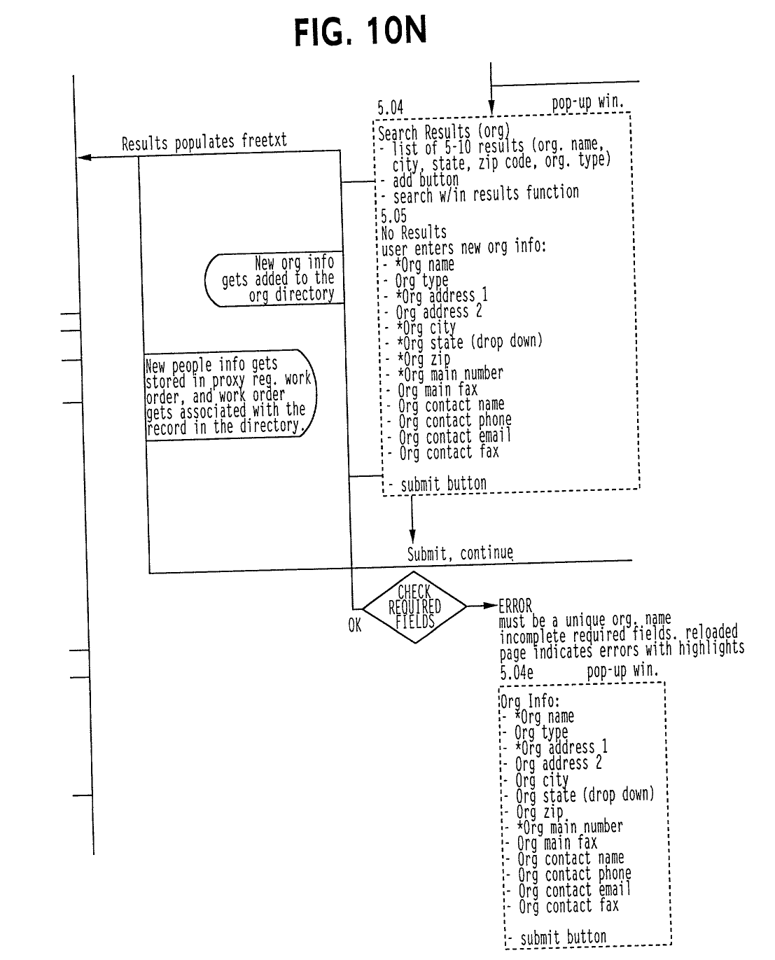

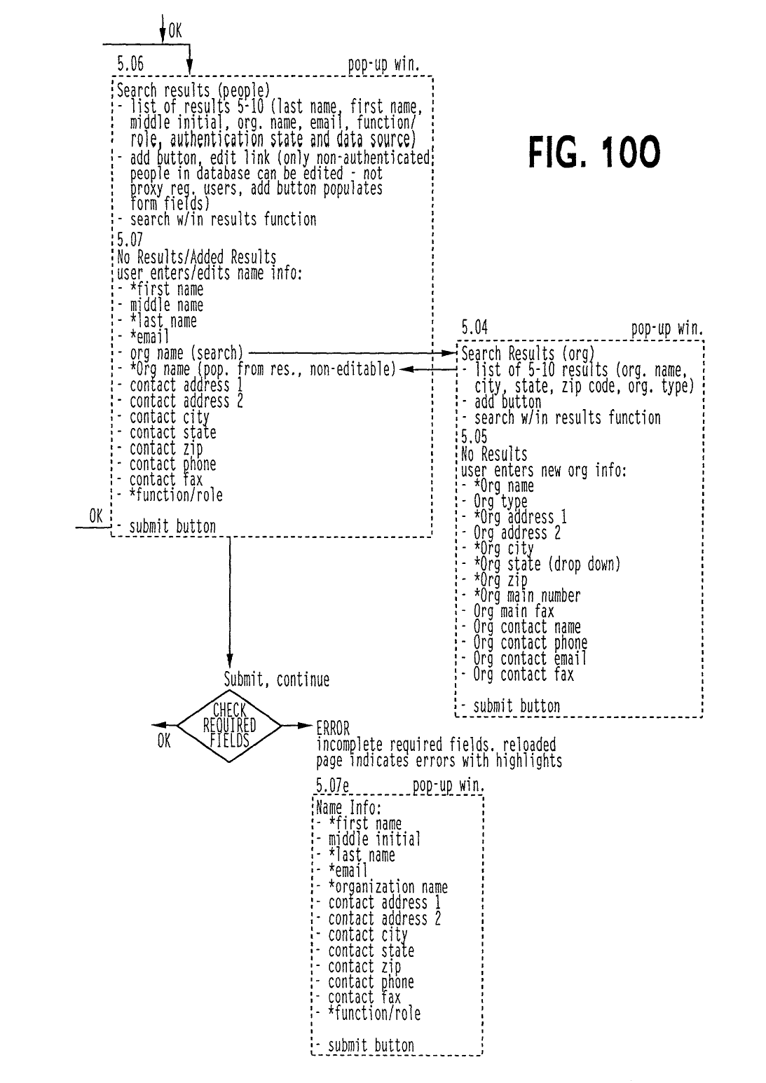

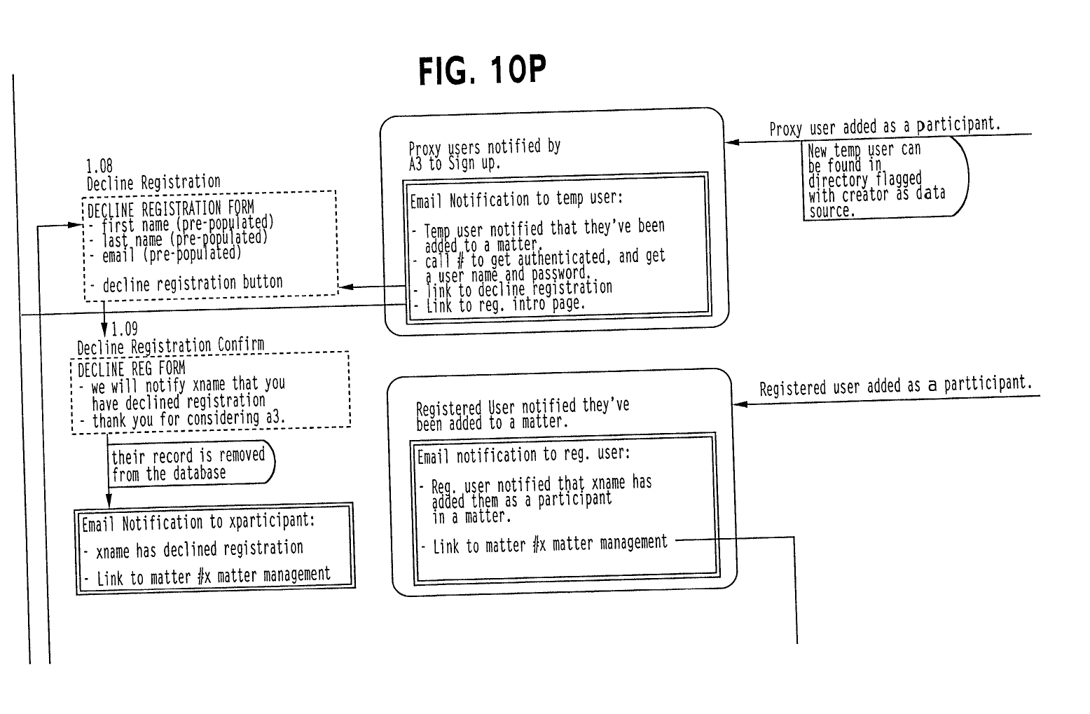

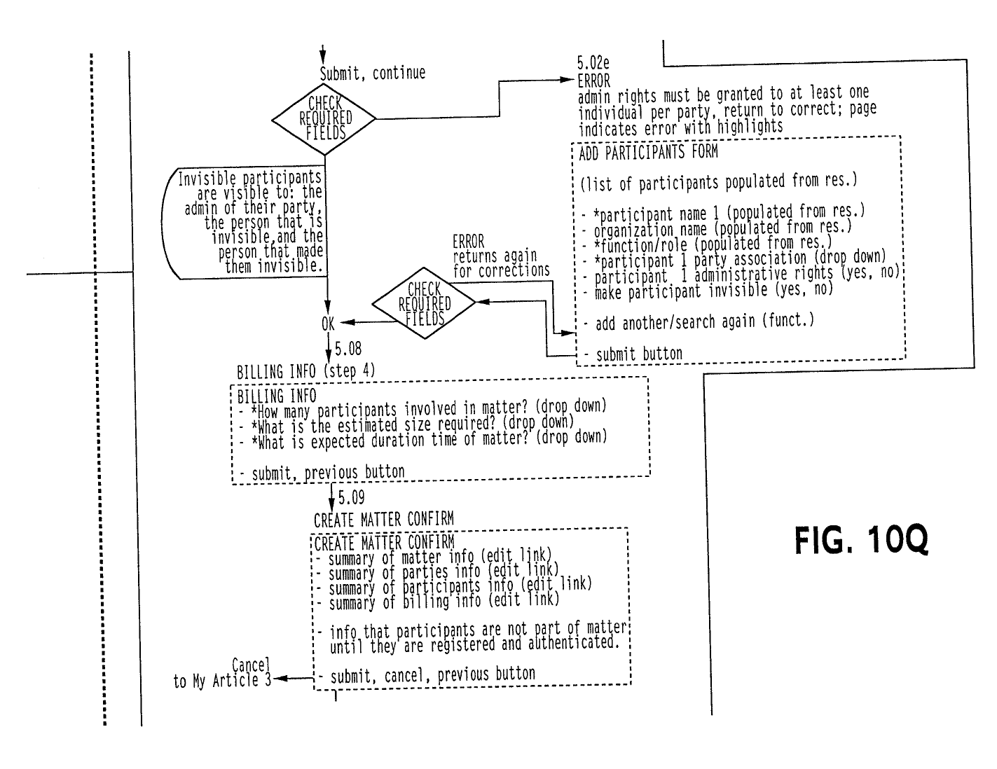

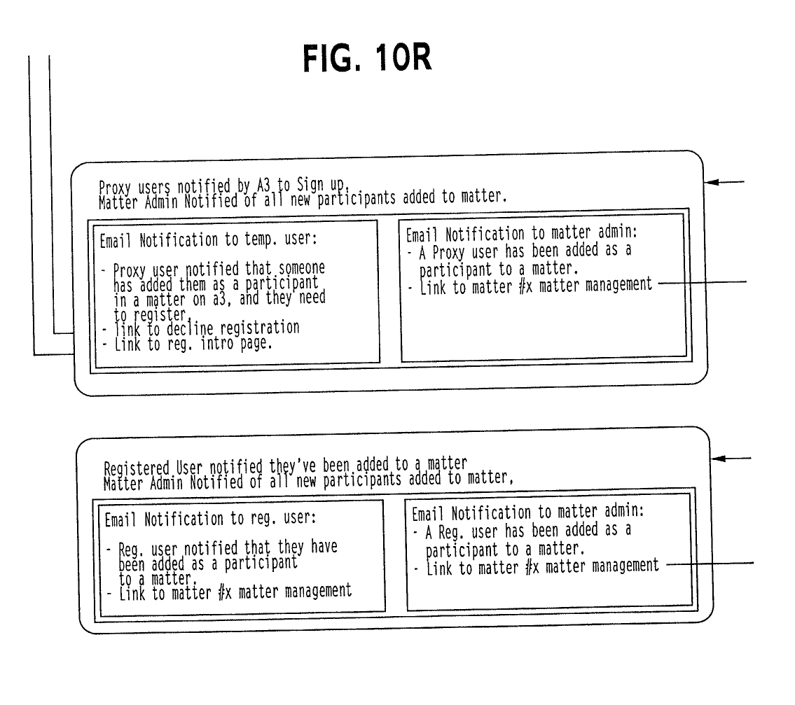

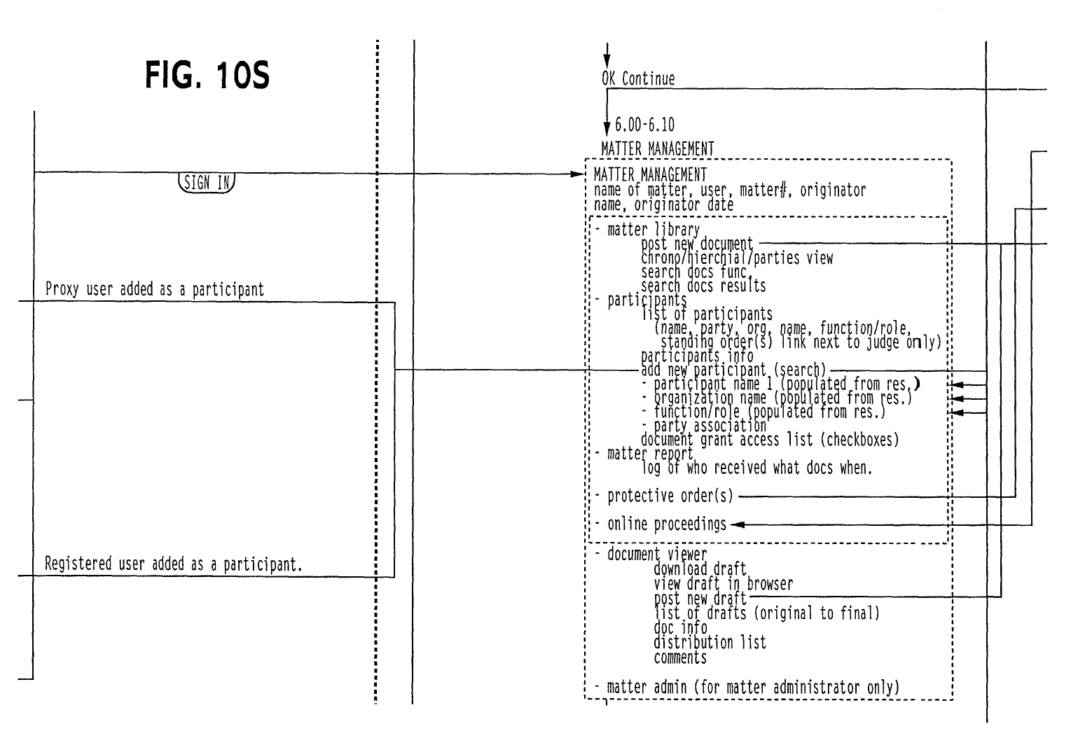

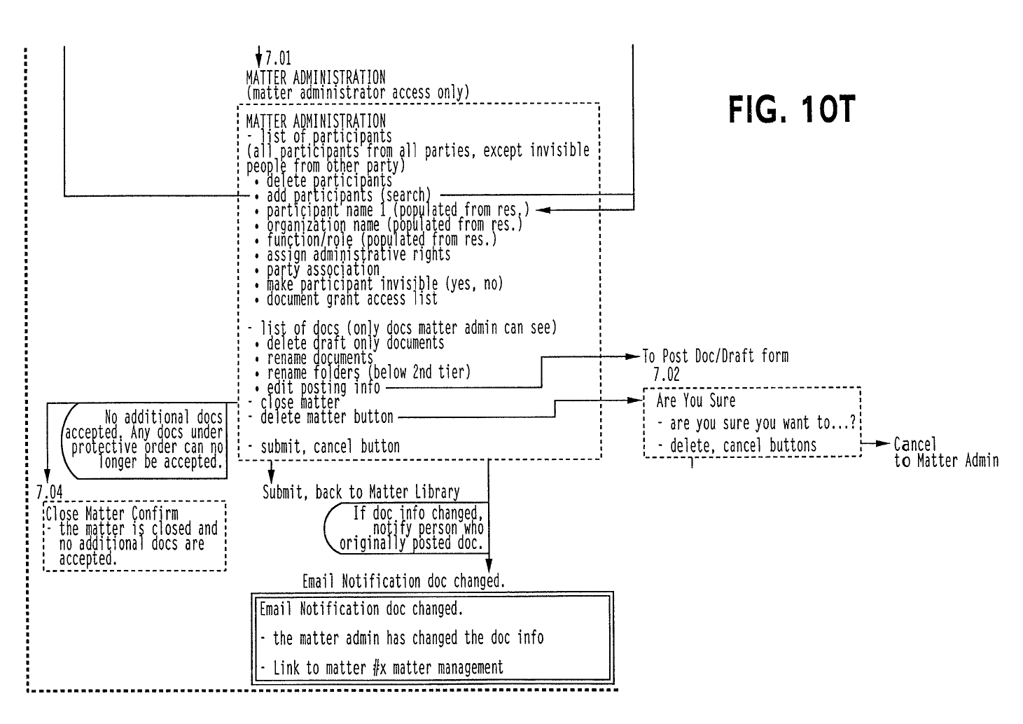

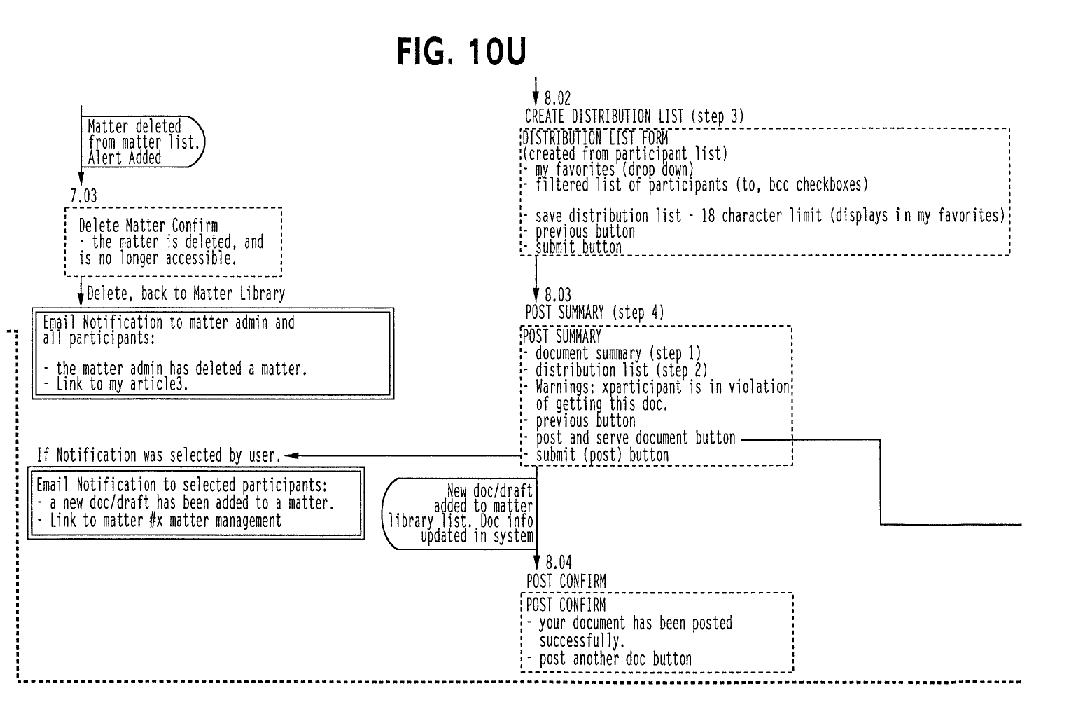

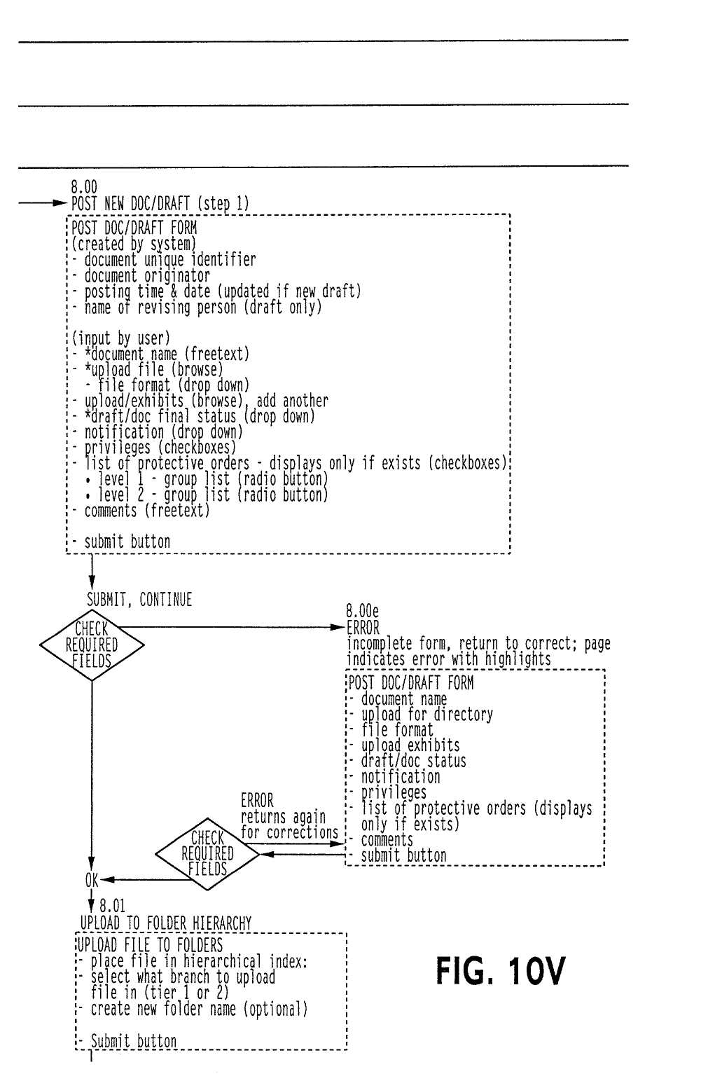

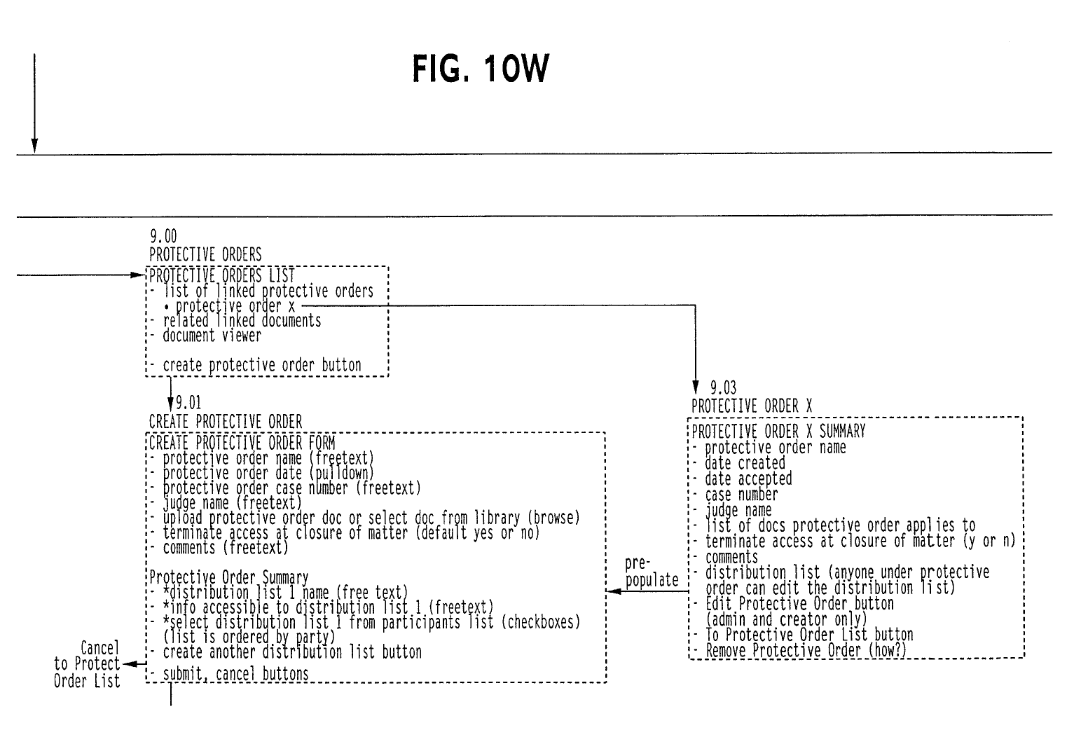

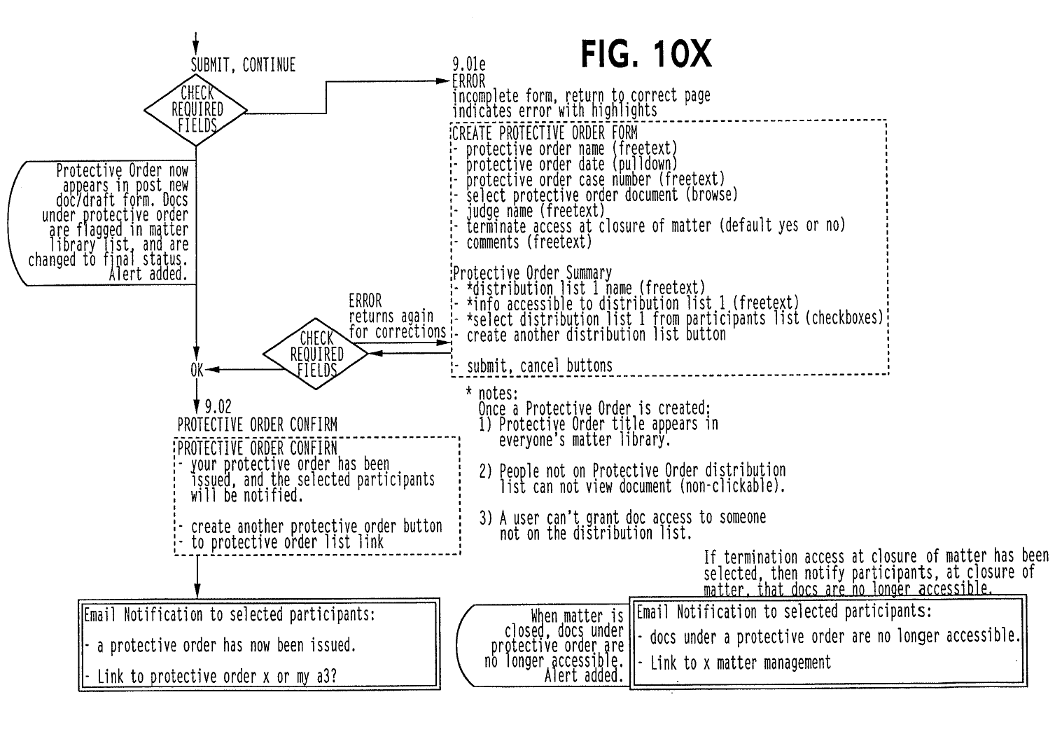

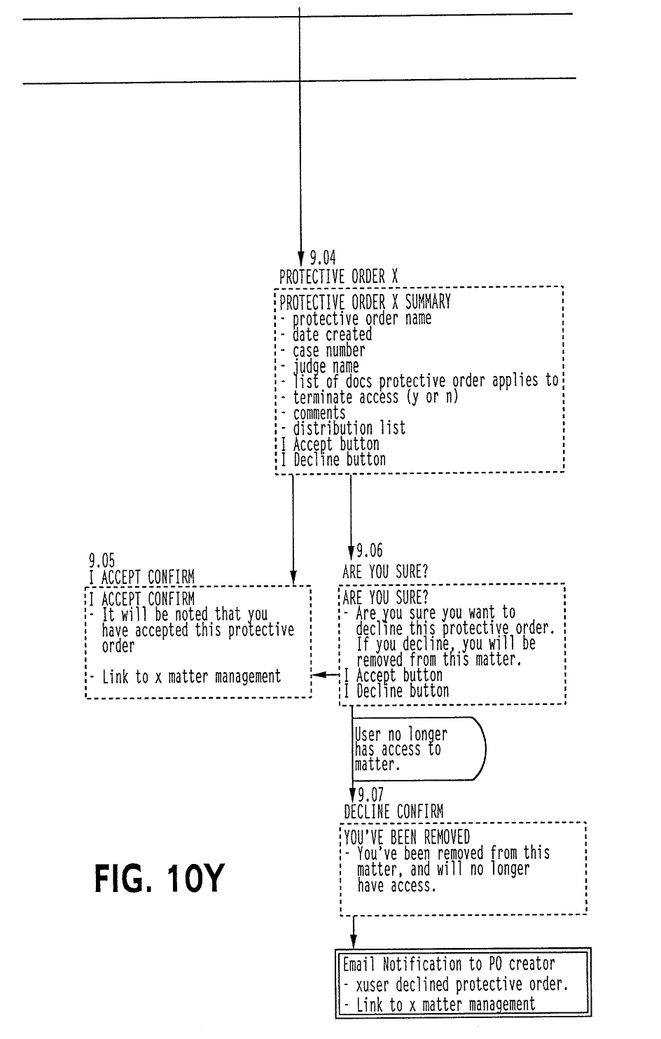

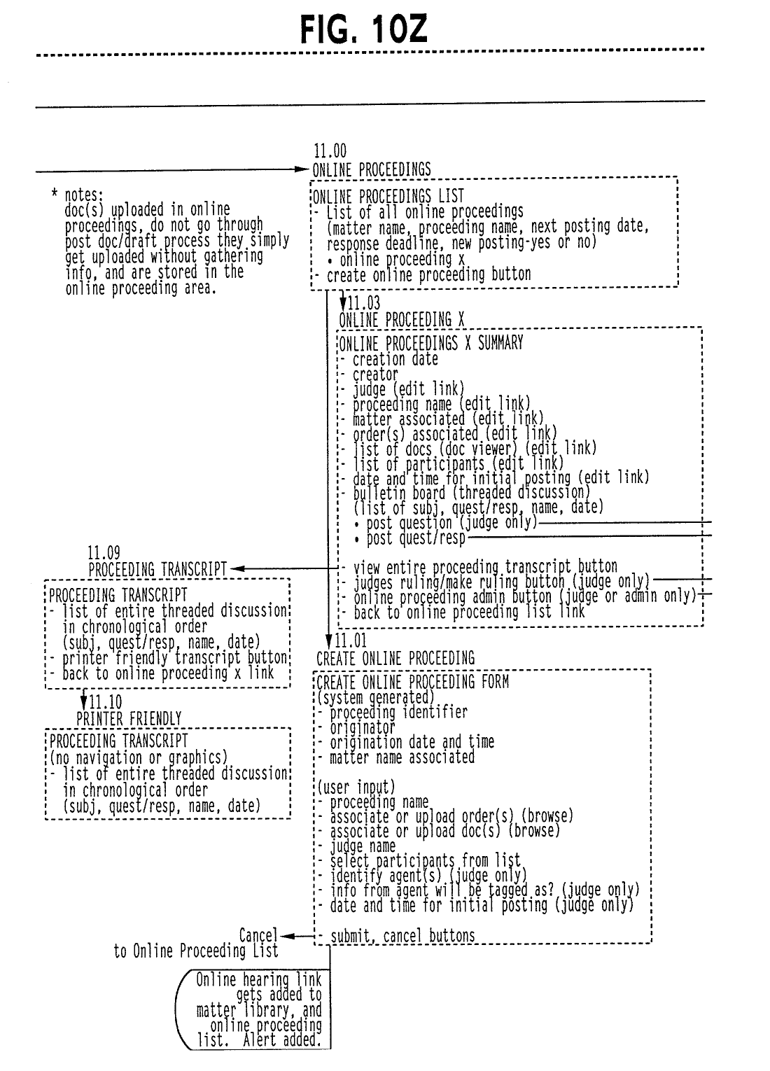

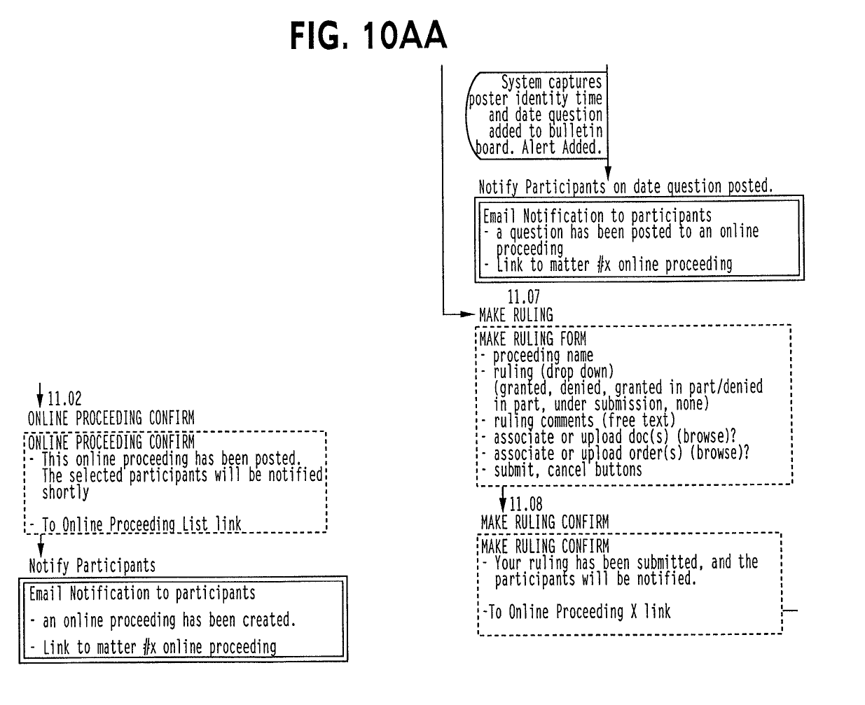

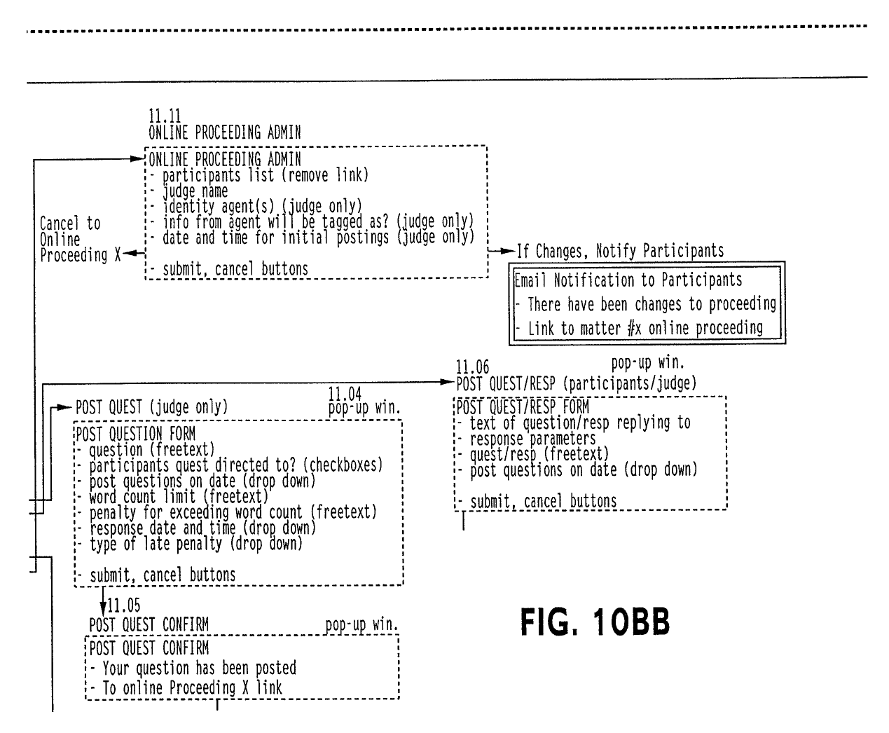

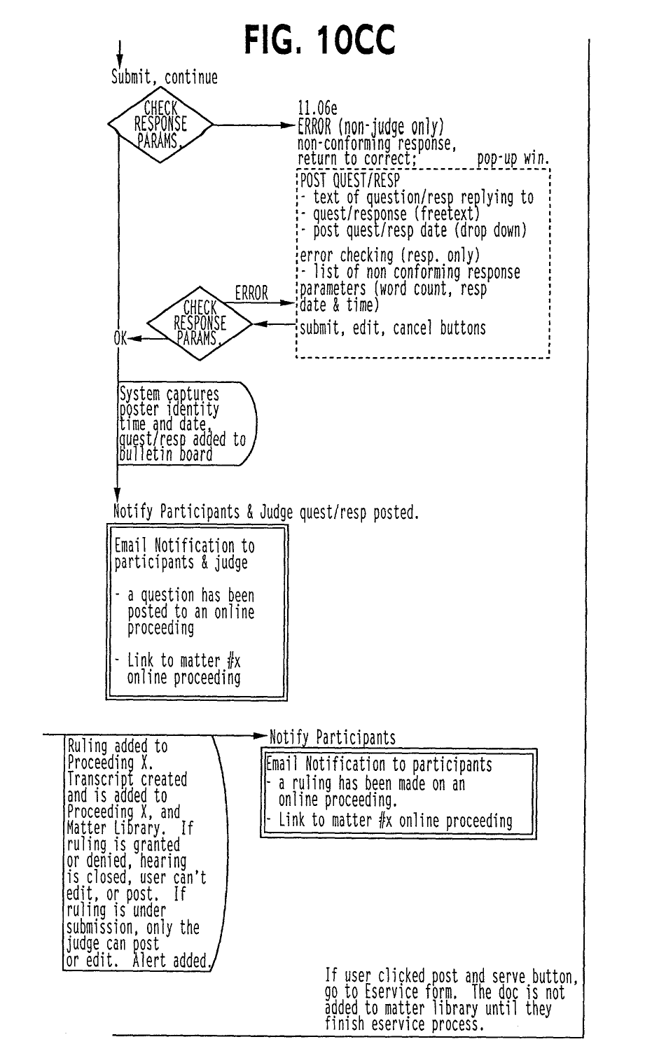

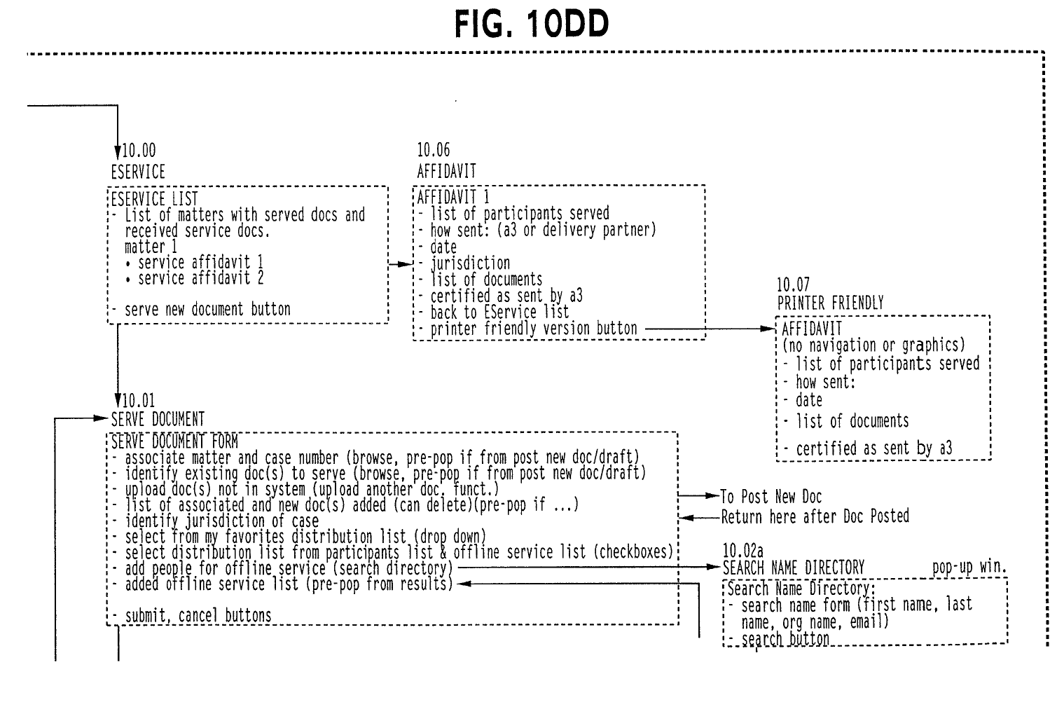

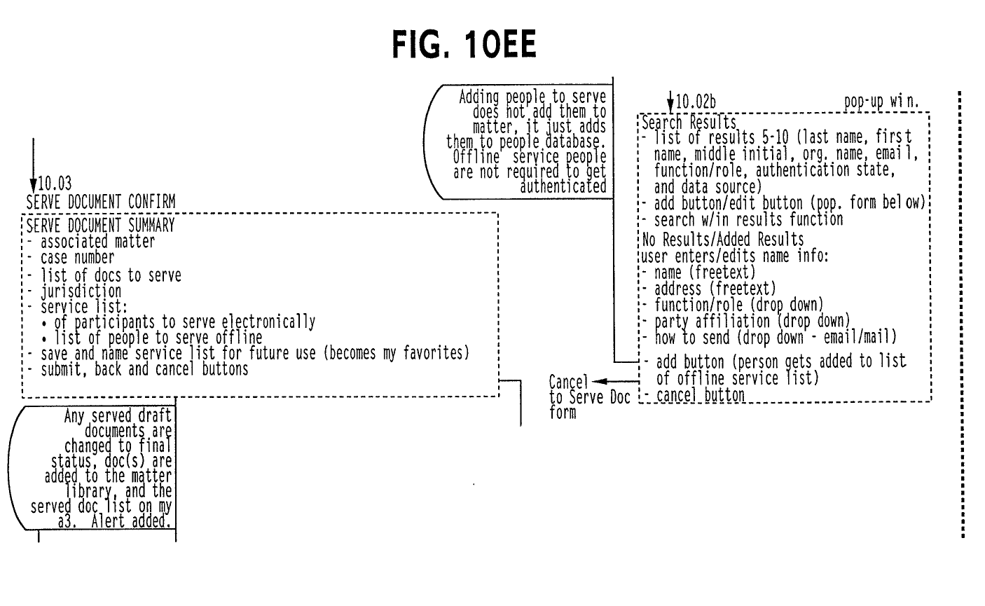

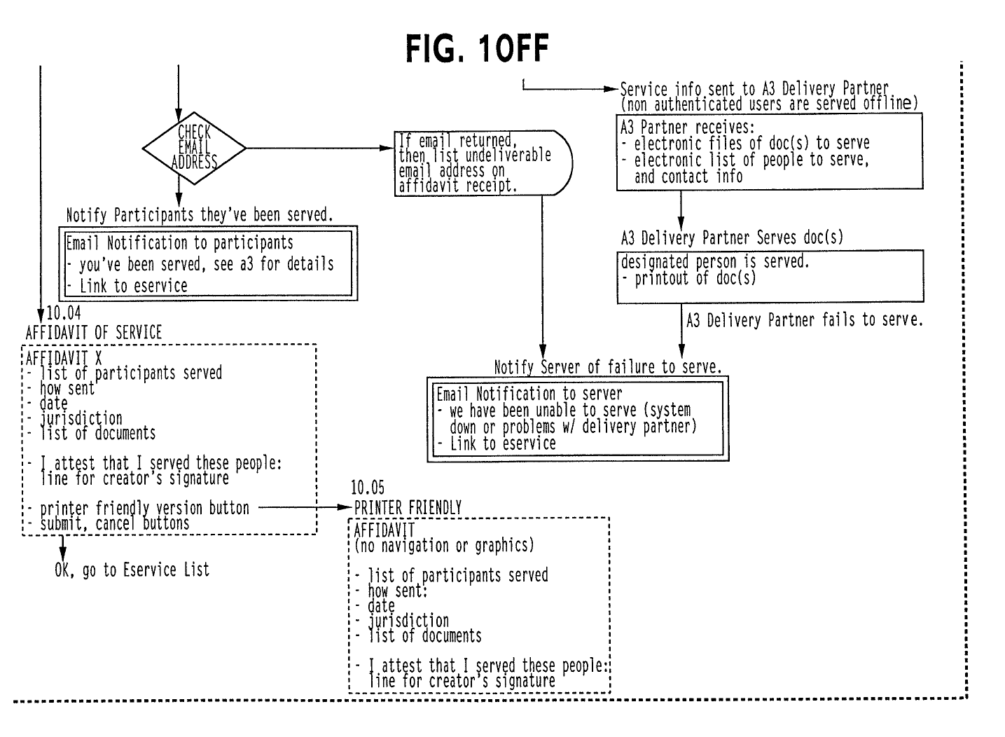

Referring now to FIG. 10 is a diagram known as a “site map” that lays out a preferred embodiment of an Internet accessible site that will permit transaction parties to engage in online operations related to a transaction processed within an access controlled environment according to a preferred embodiment of the present invention. In particular, FIG. 10 shows a map of a website 1000 that has been designed to permit transaction parties to engage in operations of the type described herein to facilitate online disposition of a transaction within an access controlled environment. Website 1000 includes multiple web pages that are coupled together in a hierarchical fashion to permit online users to engage in a multitude of transactions which may now be disposed of online and within an access controlled environment provided by the present invention. For example, website 1000 may be downloaded to and perceived via a browser client such as MICROSOFT INTERNET EXPLORER® and will be readily understood by those skilled in the art as a client server application that may be made accessible via a global network such as via the Internet. A transaction party, for example, may access website 1000 via his browser such as by traversing a uniform resource locator (URL) such as www.articleiii.com. Once accessed via a network connection, for example, website 1000 may operate like a hierarchical (menu-driven) application to permit entry into an access controlled environment, creation and modification of transaction data, etc. as described in and contemplated by this patent document. For example, a transaction party may surf to website 1000 and be presented with a homepage that allows the transaction party to register in a service facility, etc. Such operations are carried out in accordance with the process flows illustrated in FIG. 10 as the lines connecting processing nodes within website 1000. Such operations and website design will be immediately apparent to those skilled in the art after reviewing this patent document.

Accordingly, by providing a system and corresponding methods that facilitate initiation and disposition of motions such as court motions online within an access controlled environment, several benefits over prior systems and processes are realized. For example, the present invention now allows judges, for example, to initiate an online colloquy with timing, length of responses, and rules of engagement set by a court. Internet and modern security and authentication systems assure user identification and data integrity to permit colloquy to become a certified record. Automatic communications via modern mechanisms are achieved via email, fax, etc. to multiple recipients without requiring direct human intervention. Greater access to justice and other similar systems is achieved through a broader base of system users. And, new technologies are easily integrated into a common service facility so as to provide greater dissemination (e.g., automatic service of transcripts, etc.) of justice system information.

Attorneys and counselors will realize increased efficiency in terms of reducing travel time, avoidance in costs associated with the preparation for issues that do not interest a court, avoidance of overstaffing to brief issues, etc. Courts and other similar bodies will realize increased efficiencies by having clerks involved in colloquy processes earlier and more often. Judges, and other decision makers, need not appear in court to hand all motions practice and can manage colloquies from remote locations, thus possibly leading to a more specialized judiciary. And, clients and insurers and those needing access to civil and criminal justice systems, for example, benefit from reduced costs and from the ability to leverage counsel with specialized skills to assist in responding to particular queries (e.g., specific court queries, etc.).

Thus, having fully described the present invention by way of example with reference to the attached drawing figures, it will be readily appreciated that many changes and modifications may be made to the invention and to any of the exemplary embodiments shown and/or described herein without departing from the spirit or scope of the invention which is defined in the appended claims.

What is claimed is:

1. A system for facilitating initiation and disposition of a proceeding online within an access controlled environment, comprising:
an access control facility accessible via a global data processing network and configured to maintain user information, and to permit or deny a user to enter an access controlled environment within a data processing environment and to perform user operations within said access controlled environment;
a transaction management facility operable within said access controlled environment, coupled to said access control facility, and configured to store and maintain transaction data based on said proceeding, said user operations, and a security scheme; and
an authentication facility operable within said access controlled environment and configured to authenticate said transaction data based on an authentication scheme corresponding to said proceeding,
whereby said transaction management facility, said access control facility, and said authentication facility operate together to facilitate initiation and disposition of said proceeding online.

2. The system according to claim 1, wherein said global data processing network is the Internet.

3. The system according to claim 1, wherein said access control facility includes a user registration facility permitting a user to be registered based on predetermined registration criteria prior to permitting said user to access said access controlled environment.

4. The system according to claim 1, wherein said access control facility permits or denies access based on a user identifier and a user password.

5. The system according to claim 1, wherein said transaction management facility is further configured to automatically notify said user based upon a change to said transaction data.

6. The system according to claim 5, wherein said transaction management facility notifies said user via an automatically generated electronic mail message.

7. The system according to claim 6, wherein said automatically generated electronic mail message contains a reference to said transaction based on a predetermined level of vagueness.

8. The system according to claim 1, wherein said proceeding is an online motion in the context of a legal proceeding.

9. The system according to claim 1, wherein said proceeding is an administrative motion proceeding.

10. A method for facilitating initiation and disposition of a proceeding online within an access controlled environment, comprising the steps of:
permitting at least one transaction party to create an access controlled environment corresponding to said proceeding;
permitting said at least one transaction party to initiate said proceeding online to correspond to said access controlled environment;
permitting a decision maker to enter said access controlled environment and to set rules for processing said proceeding online within said access controlled environment and to raise inquiries intended to be responded to by said at least one transaction party;
permitting said at least one transaction party to enter said access controlled environment and to submit responses to said inquiries online;
permitting a decision maker to act upon said responses and said proceeding to reach a decision determining the outcome of said proceeding so as to dispose of said proceeding; and
posting said decision within said access controlled environment and notifying said transaction parties of said decision.

11. The method according to claim 10, wherein said proceeding is an online motion in the context of a legal proceeding.

12. The method according to claim 10, wherein said rules govern the way said transaction parties process said proceeding and interact with said decision maker.

13. The method according to claim 10, wherein said rules include response time limits.

14. The method according to claim 10, wherein said rules include word count requirements set to correspond to responses from said transaction parties.

15. The method according to claim 10, wherein said rules correspond to court rules.

16. A system for facilitating initiation and disposition of an online motion within an access controlled environment within the context of a court proceeding, comprising:
an access control facility accessible via a global data processing network and configured to maintain user information, and to permit or deny a user to enter an access controlled environment within a data processing environment and to perform user operations within said access controlled environment related to said online motion;
a transaction management facility operable within said access controlled environment, coupled to said access control facility, and configured to store and maintain transaction data based on said online motion, said user operations, and a security scheme; and
an authentication facility operable within said access controlled environment and configured to authenticate said transaction data based on an authentication scheme corresponding to said online motion,
whereby said transaction management facility, said access control facility, and said authentication facility operate together to facilitate disposition of said online motion.

17. The system according to claim 16, wherein said global data processing network is the Internet.

18. The system according to claim 16, wherein said access control facility includes a user registration facility permitting a user to be registered based on predetermined registration criteria prior to permitting said user to access said access controlled environment.

19. The system according to claim 16, wherein said access control facility permits or denies access based on a user identifier and a user password.

20. The system according to claim 16, wherein said transaction management facility is further configured to automatically notify said user based upon a change to said transaction data.

21. The system according to claim 20, wherein said transaction management facility notifies said user via an automatically generated electronic mail message.

22. The system according to claim 21, wherein said automatically generated electronic mail message contains a reference to said online motion based on a predetermined level of vagueness.
